(19) United States
(12) Patent Application Publication
(10) Pub. No.: US 2023/0237726 A1
(43) Pub. Date: Jul. 27, 2023

(54) SOFTWARE WITH MOTION RECORDING FEATURE TO SIMPLIFY ANIMATION

(71) Applicant: Dodles, Inc., Combined Locks, WI (US)

(72) Inventors: Craig W. Doriot, Combined Locks, WI (US); Ronald Dean Strawbridge, St. Louis, MO (US)

(73) Assignee: Dodles, Inc., Combined Locks, WI (US)

(21) Appl. No.: 18/130,240

(22) Filed: Apr. 3, 2023

Related U.S. Application Data
(63) Continuation of application No. 17/282,440, filed on Apr. 2, 2021, now abandoned.
(60) Provisional application No. 62/740,656, filed on Oct. 3, 2018.

(51) Int. Cl. G06T 13/80; A63F 13/2145; A63F 13/537; G06F 3/0484; G06F 3/0488

(52) U.S. Cl. CPC G06T 13/80; A63F 13/2145; A63F 13/537; G06F 3/0484; G06F 3/0488

(57) ABSTRACT

Features of a software program designed to facilitate animation by users of handheld or portable electronic devices are described. The software program may be in the form of instructions suitable to be carried out by the microprocessor of such a device in response to inputs from the user. The software provides a motion recording feature in which a user input in the form of a pointer, touch point, or other position-related input is monitored over the course of a recording session, converted to a data string of attribute values, and stored in memory. The software displays an animation of a virtual object over an animation period by retrieving the data string of attribute values from the memory and causing the processor to generate the animation using the retrieved data string of attribute values

### CROSS-REFERENCE TO RELATED APPLICATIONS

This application claims priority under 35 U.S.C. § 119 (e) to provisional patent application U.S. Ser. No. 62/740,656, “More Computer Methods and Systems for Automated or Assisted Animation”, filed Oct. 3, 2018, the contents of which are incorporated herein by reference.

### FIELD OF THE INVENTION

The present disclosure relates generally to software, and more particularly, software that provides graphical user interfaces (GUIs) on the display of a portable electronic device, the software being specially designed or adapted to help a user of the device create, modify, or enhance animations of virtual objects, such as drawing(s) or images of one or more characters or things. The disclosure also relates to associated articles, systems, and methods.

### BACKGROUND

Numerous software products—referred to herein as software programs, or simply, programs—are known. Many years ago, most software programs were designed for use on desktop or laptop computers, in which the display is at least about the size of a standard sheet of office paper, e.g., 8.5×11 inches. Stated differently, the display for such devices has a characteristic dimension of at least about 14 inches, measured diagonally between opposite corners of the generally rectangular display screen.

In recent years there has been explosive growth in the sales of smart phones, tablet computers, smart watches, and similar handheld devices, whose display screens have characteristic dimensions substantially smaller than 14 inches. The screen size on a handheld device may be for example less than 9 inches, or less than 8 inches, or in a range from 1 to 9 inches or from 4 to 8 inches. Most smart phones have screen sizes from 6 to 7 inches. Despite the small size of the display screen, software programs made for use with such handheld devices, sometimes referred to as applications or “apps”, can have a high degree of functionality and complexity.

Nevertheless, some computer-based activities—such as professional quality or near-professional quality animation—are so highly detailed in terms of depth of tools for the animator, and demanding on the capabilities of the microprocessor, that they are still predominantly the domain of the larger, more powerful desktop computers.

There is an ongoing need for new software tools and features, and in particular, software programs and features that can make high quality animation and drawing easier and faster to create, and accessible to more people. We believe in this regard it would also be desirable for such new software to be optimized for, or at least be compatible with, the smaller display screens and processors of handheld and other portable electronic devices.

### SUMMARY

We disclose herein, among other things, a software program or package that is capable of being used on a handheld device, although the software is not limited to such devices and can also be used on larger, more powerful electronic devices. The software provides graphical user interfaces (GUIs) or graphics displays that make it easy for a user to create, modify, save, and/or import one or more virtual objects, and to create, define, modify, and/or save animations to be performed on such object(s). The virtual object(s) may be or comprise one or more of characters, scenes, and objects such as vehicles, dwellings, etc. The disclosed techniques can be employed to allow a user who is not otherwise proficient in animation to animate such object(s) on a handheld device with simple finger taps, gestures, or the like, hence the techniques may be loosely grouped under the umbrella term of simplified animation.

We also disclose software designed to facilitate animation by users of handheld or portable electronic devices. The software provides a motion recording feature in which a user input in the form of a pointer, touch point, or other position-related input is monitored over the course of a recording session, converted to a data string of attribute values, and stored in memory. The software displays an animation of a virtual object over an animation period by retrieving the data string of attribute values from the memory and causing the processor to generate the animation using the retrieved data string of attribute values. The software program may be in the form of computer-readable instructions, a sequence of which can be used to form an effect, suitable to be carried out on the virtual objects by the microprocessor of such a device, causing the objects to animate when the animation applied to the object is activated by reaching a designated moment in an animation timeline, which is a virtual representation of the effects according to a timed sequence, or based on a more discrete sequence that is triggered by external factors, such as in response to a user input.

Also of interest is the process by which these effects are designated and configured by the user, and the ease and speed by which the user can apply new effects to an animation timeline. The process of recording the timing and positioning of an object attribute's keyframes through input over time of an input device such as a finger, stylus, or mouse offers a faster and more robust method for defining animation sequences. Multiple effects can be combined to form larger effects, and simpler motions with fewer clicks can allow the user to speed the process of applying fairly complex effects.

We also disclose methods for automating animation on an electronic device, comprising: providing an electronic device having a processor, a memory, and a screen, the processor configured to provide video signals to the screen, and to read and write information to and from the memory; displaying graphics on the screen, and defining one or more attribute input regions on the screen, different locations on the attribute input region(s) corresponding to different visual attribute values for a virtual object to be displayed on the screen; receiving user position signals produced by a user interacting with the attribute input region(s) over a recording period; converting the received user position signals to a data string of attribute values over the recording period; storing the data string of attribute values in the memory; and displaying on the screen an animation of the virtual object over an animation period by retrieving the data string of attribute values from the memory and causing the processor to generate the animation using the retrieved data string of attribute values. We also disclose non-transitory computer-readable storage medium having instructions that, when executed by a processing device having a processor, a memory, and a screen, cause the processing device to perform the foregoing operations.

We also disclose methods for automating animation on an electronic device, comprising: providing an electronic device having a processor, a memory, and a screen, the screen operable as both a display screen and a touch screen, the processor configured to receive touch signals from the screen and to provide video signals to the screen, the processor also configured to store first information to the memory and to read second information from the memory; generating a graphical user interface (GUI) on the screen, the GUI defining one or more attribute input regions on the screen, different locations on the attribute input region(s) corresponding to different visual attribute values for one or more virtual objects to be displayed on the screen; receiving touch signals produced by a user interacting with the attribute input region(s) over a recording period, and converting the received touch signals to a data string of attribute values over the recording period; storing the data string of attribute values in the memory; and displaying on the screen an animation of the one or more virtual objects over an animation period by retrieving the data string of attribute values from the memory and causing the processor to generate the animation using the retrieved data string of attribute values.

Numerous related methods, systems, and articles are also disclosed.

These and many other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

The inventive animation software and related methods, devices, and systems are described with reference to the attached drawings, of which:

FIG. 1 is a front view of a smart phone or similar handheld device capable of running the disclosed software;

FIG. 2 is a front view of a tablet device capable of running the software;

FIG. 3 is a perspective view of a laptop device capable of running the software;

FIG. 4 is a block diagram showing a system that includes an electronic device and key subsystems thereof, and software in the form of instructions that can be loaded onto the electronic device;

FIGS. 5A-5D. 6A, 6B, 7A-7C, 8, 9A-9C, 10, 11A-11D, 12A-12C, 13A-13C, 14A-14D, 15A-15F, 16A-16D. 17A. 17B. 18A. 18B. 19A-19E, 20A-20E, 21A-21D, 22A, 22B, 23A-23D, 24A-24D, 25A-25C, 26A-26C, 27A-27D, and 28A-28C are images of the display screen or other output screen of a microprocessor-based electronic device for different aspects or functions of the software, these images including exemplary graphical user interfaces (GUIs) for such software functions;

FIG. 29 is a flowchart of a method of simplified animation that involves taking a recording of a user interaction with a portion of a touch screen associated with an attribute of a virtual object;

FIG. 30 is a graph of a curve that represents hypothetical or possible user-generated position data that the system uses to produce automated animation effects;

FIG. 31 is a graph similar to that of FIG. 30 but where the hypothetical user-generated position data is of a binary nature; and

FIG. 32 is a graph similar to that of FIG. 30 but where a smoothing filter or other signal processing operator(s) have been used to produce a smoothed position data file for use in simplified animation.

In the figures, like reference numerals designate like elements.

### DETAILED DESCRIPTION OF ILLUSTRATIVE EMBODIMENTS

High quality drawing and animation tools and capabilities can be made available to the general public with the help of software, but in order to gain traction the software should provide intuitive and innovative capabilities and features that give the user a sufficient array of tools to carry out basic drawing and animation tasks quickly and easily. We disclose such capabilities below with reference to GUIs and views of the display screen generated by the software, which a user can interact with by means of a touch screen, touch pad, mouse, keyboard, or other input device in the form of mouse clicks, screen touches, swipes, gestures, and other user inputs, including also in particular where the user maintains a touch or contact paint with the touch screen, etc. over an extended period of time (recording session) while moving the touch point as desired along a path (motion path) to control a visual attribute of a virtual object.

In the description that follows, a variety of software functions are described, including a move effect, a master effect, timeline manipulation, a rotate effect, a scale effect, a visibility effect, a copy effect, a flip effect, object phases, animated scenes, animation timeline, object chest, timeline manipulation, bone manipulation, scene change, camera effects, phase manipulation, timeline blocks, and drill navigation. One, some, or all of the described functions may be included in a given commercial embodiment of the software, as well as one or more additional functions not described here. The software provides GUIs that allow a user to create and modify a virtual object, and to create, define, and save animations of that object for future use. The virtual object may be or comprise one or more of characters, scenes, and objects such as vehicles, dwellings, etc.

In the figures, for illustrative purposes, many of the screens depict a virtual object in the form of a female character having a head, torso, arms, legs, and feet. Such an object may be created using the same software, or by any other means and then imported into the software. The reader will understand that the particular female character depicted or the character's body parts in the figures can be replaced by other virtual objects, including human characters, non-human characters, and inanimate objects, for example.

### Platform Devices and Systems

Some electronic devices on which the software can be run will now be discussed. To the extent such devices all include a microprocessor, memory, and input and output means, they may be considered to be computers for purposes of this document, and the actions and sequences carried out by the software may be considered to be computer-implemented methods. The reader will understand that the software is implemented in the form of instructions suitable to be carried out by the microprocessors of such electronic devices. Such instructions can be stored in any suitable computer language or format on a non-transitory storage medium capable of being read by a computer. Such a computer-readable storage medium may be or include, for example, random access memory (RAM), read only memory (ROM), read/write memory, flash memory, magnetic media, optical media, or the like.

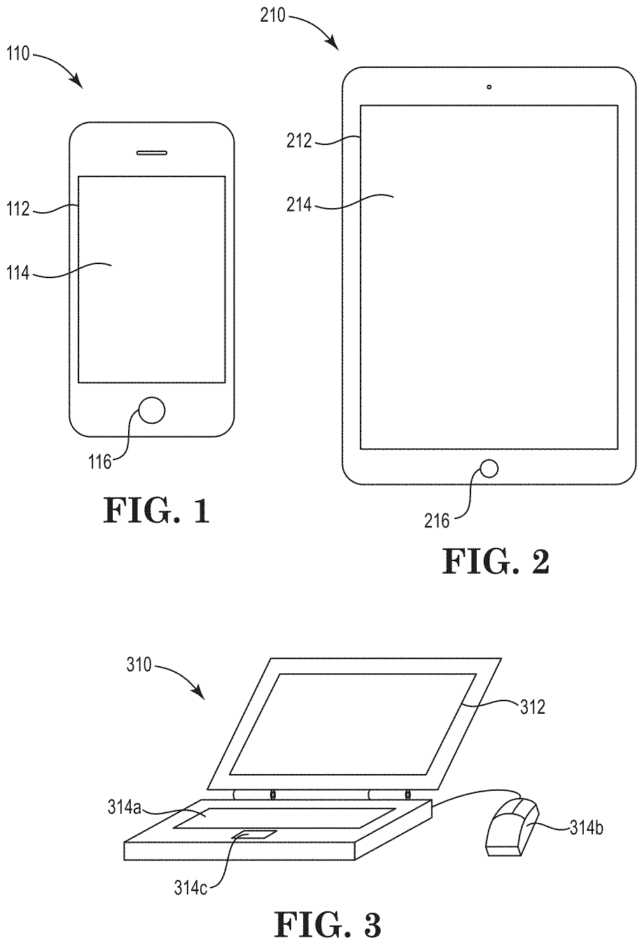

Representative portable electronic devices that can be used to load and run the animation software described above are shown in FIGS. 1, 2 and 3. FIG. 1 is a front view of a smart phone 110. The smart phone 110 includes a display screen 112, a touch screen 114, one or more physical buttons 116, and other input and output components such as microphones, cameras, speakers, antennas, and electronic connectors, as well as optional external components connected wirelessly or by wired connections such as physical keyboards, track balls, joysticks, eye-tracking devices, and auxiliary display screens. The touch screen 114 is typically substantially coextensive with the display screen 112. FIG. 2 is a front view of a tablet computer 210. Like the smart phone 110, the tablet 210 includes a display screen 212, a touch screen 214, one or more physical buttons 216, and other input and output components, as discussed. The touch screen 214 is typically substantially coextensive with the display screen 212. Although the screen 212 is larger than the screen 112, both of these display screens have relatively small characteristic dimensions as discussed above, e.g., in a range from 4 to 8 inches. In this regard, it is important that software running on such small devices make efficient use of the limited display area available.

The device of FIG. 3 is a laptop computer 310. The computer 310 includes: a display screen 312; various user input mechanisms such as a physical keyboard 314a, a mouse 314b, and a track pad 314e; and other input and output components such as those discussed above.

Each device 110, 210, 310 includes a display on which the graphical user interface (GUI) of the software can be shown. Each device also includes input mechanisms that allow the user to enter information, such as make selections, enter alphanumeric data, trace freeform drawings, and so forth. In the case of the smart phone 110 and tablet 210, the primary input mechanism is the touch screen, although the laptop 310 may of course also include a touch screen. The graphical user interface (GUI) provided by the software may be designed to display virtual buttons on the output screen, which the user may selectively activate or trigger by touching the touch screen at the location of the desired virtual button with a finger or pen, or by moving a cursor to that location with a mouse or track pad and selecting with a “click”.

In this regard, a virtual button is like a physical button insofar as both can be user-activated or triggered by touching, pushing, or otherwise selecting, but unlike it insofar as the virtual button has no physical structure apart from the display screen, and its position, size, shape, and appearance are provided only by a graphical depiction on the screen. A virtual button may refer to a bounded portion of a display screen that, when activated or triggered, such as by a mouse click or a touch on a touch screen, causes the software to take a specific, defined action such as opening, closing, saving, or modifying a given task or window. A virtual button may include a graphic image that includes a closed boundary feature, such as a circle, rectangle, or other polygon, that defines the specific area on the display screen which, when touched or clicked, will cause the software to take the specified action. Virtual buttons require none of the physical hardware components associated with mechanical buttons.

The devices 110, 210, 310 all typically include a microprocessor, memory, and input and output means. As such, these devices may all be considered to be computers for purposes of this document, and actions and sequences carried out by the software on such devices may be considered to be computer-implemented methods. The software disclosed herein can be readily encoded by a person of ordinary skill in the art into a suitable digital language, and implemented in the form of instructions that can be carried out by the microprocessors of the devices 110, 210, and 310. Such instructions can be stored in any suitable computer language or format on a non-transitory storage medium capable of being read by a computer. Such a computer-readable storage medium may be or include, for example, random access memory (RAM), read only memory (ROM), read/write memory, flash memory, magnetic media, optical media, or the like.

In some cases the display screens of devices 110, 210, 310 may all be replaced, or supplemented, with a projected display screen made by projecting a screen image onto a wall or other suitable surface (remote from the electronic device) with a projector module. The projector module may be built into the electronic device, or it may be a peripheral add-on connected to the device by a wired or wireless link. The projector module may also project a virtual image of the display into the user's eyes, e.g., via suitable eyeglass frames or goggles.

The representative devices 110, 210, 310 should not be construed as limiting. The disclosed software and its various features can be run on any number of electronic devices, whether large screen or small screen. Other devices of interest include the category of smart watches, which may have a screen size in the 1 to 2 inch range, or on the order of 1 inch. Still other devices include touch screen TVs, whether large, medium, or small format.

Regardless of the electronic device chosen by the user and its specific capabilities and specifications, the input mechanism(s) allow the user to interact with the software by means of the GUI displayed on the screen, such as by activating or triggering virtual buttons on the display, or drawing a figure or shape by freeform tracing, using a touch screen, touch pad, mouse, or other known input mechanism.

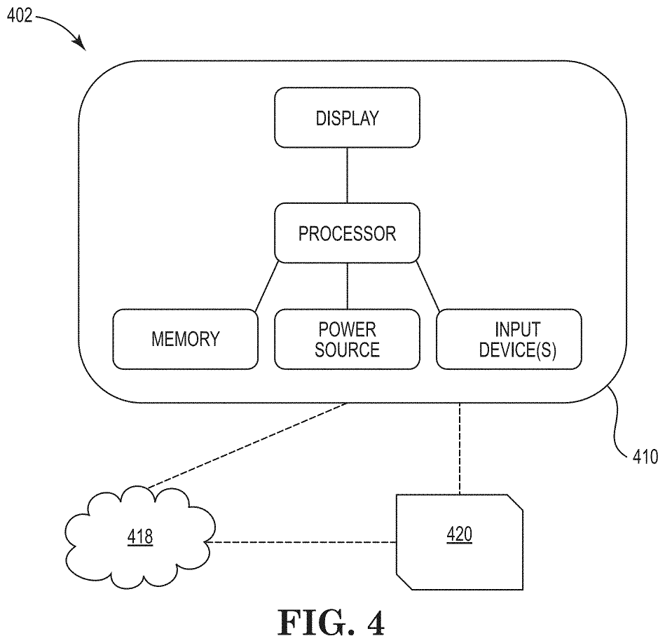

A block diagram of a system 402 that includes an electronic device 410 and software in the form of instructions 420 that can be loaded directly or indirectly onto the electronic device 410 is shown in FIG. 4. The device 410 may for example be any of the devices 110, 210, or 310 discussed above. Selected components or subsystems of the device 410 are also shown, in particular, a processor, memory (including at least RAM and ROM), input device(s), and a display, as well as a power source. These subsystems and their respective functions, as well as other subsystems and components of state-of-the-art portable electronic devices, are well known in the art, and need not be discussed further. The device 410 may also connect to at least one remote device, computer, or host 418 through one or more intermediate networks, such as the internet or world-wide-web, or through a wireless cell phone digital data link, or by other connections, networks, or links now known or later developed. The broken lines in FIG. 4 illustrate that the instructions 420 can be provided to the processor of the device 410, and loaded into the memory of the device 410, either directly, or indirectly by first being loaded into the remote host 418 and then being transferred or copied from the host 418 to the device 410.

### Animation Overview

Users can apply simple effects to their creations to create proprietary animations capable of export as animated gif (graphics interchange format) files and videos.

### Animation Views

There may be four major animation views within the software application. Users can trigger the Effects view, which lets them apply pre-canned (i.e. predefined) effects to the animations. Effects are divided into Base Effects and Master Effects (user-defined effects or “canimations”). Base Effects are the basic building blocks that constitute all of the possible system effects. The Master Effect allows users to define their own effect as a superset combination of effects, turning this group of configured effects into a Master Effect or “canimation” when saved into their effect library.

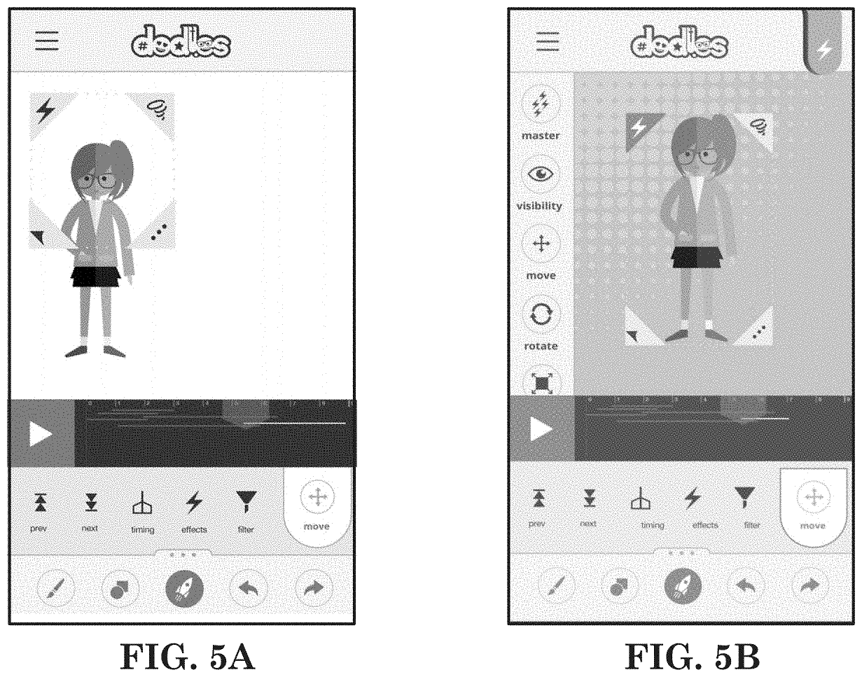

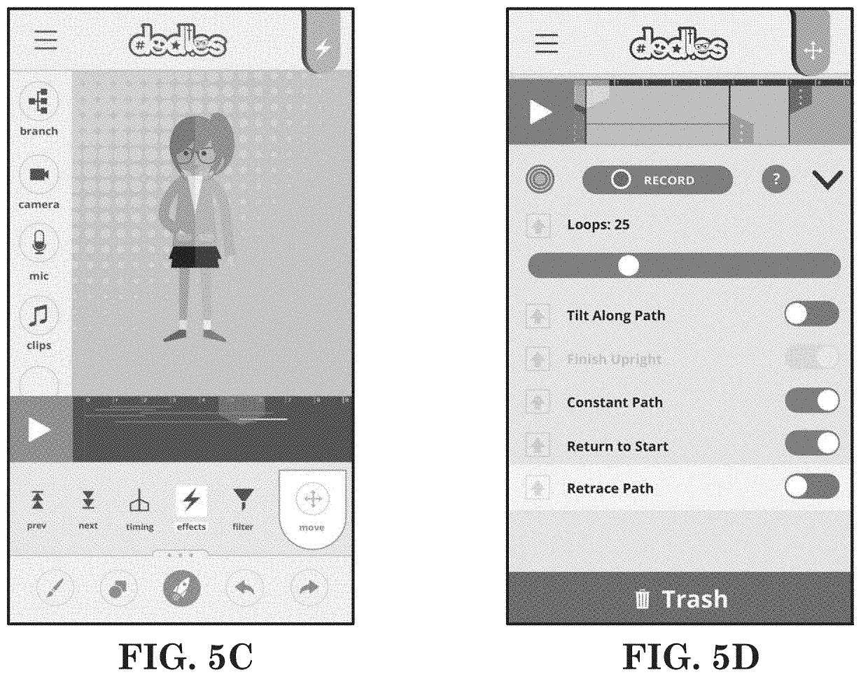

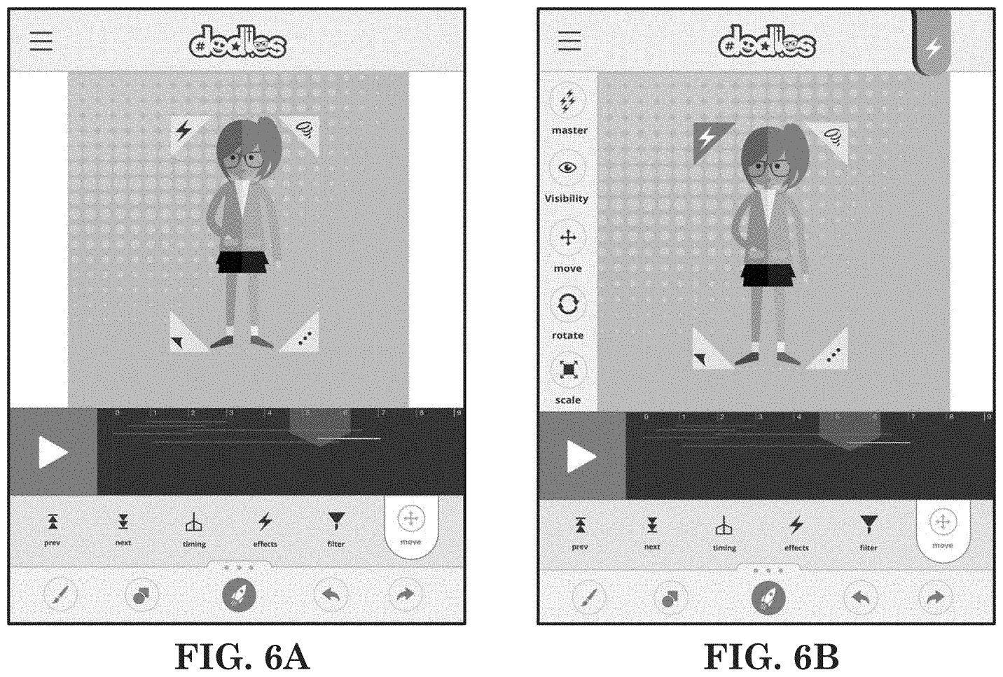

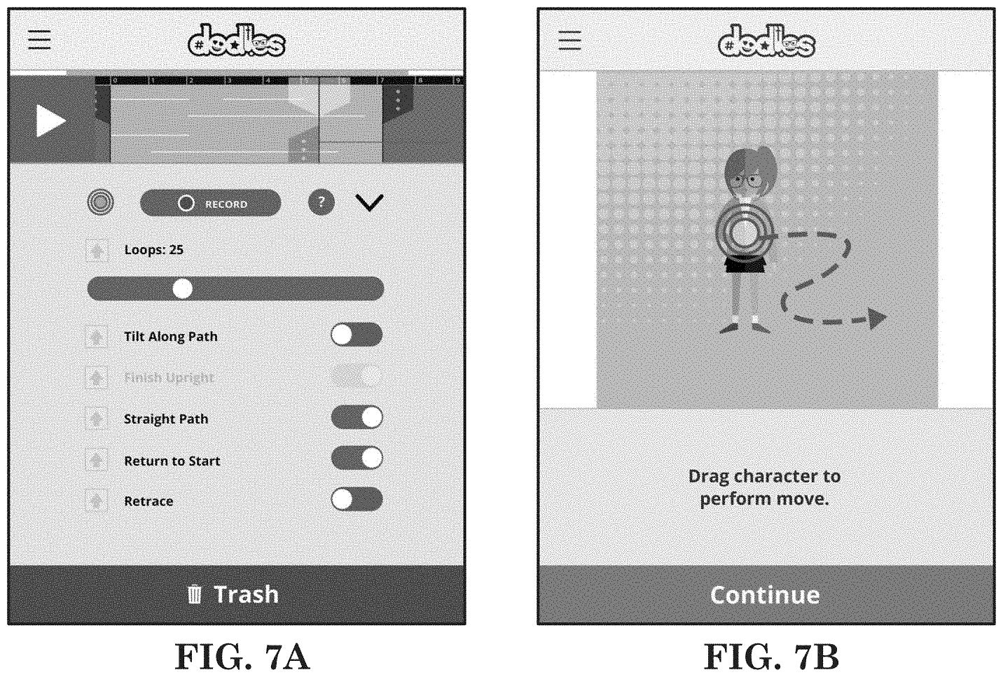

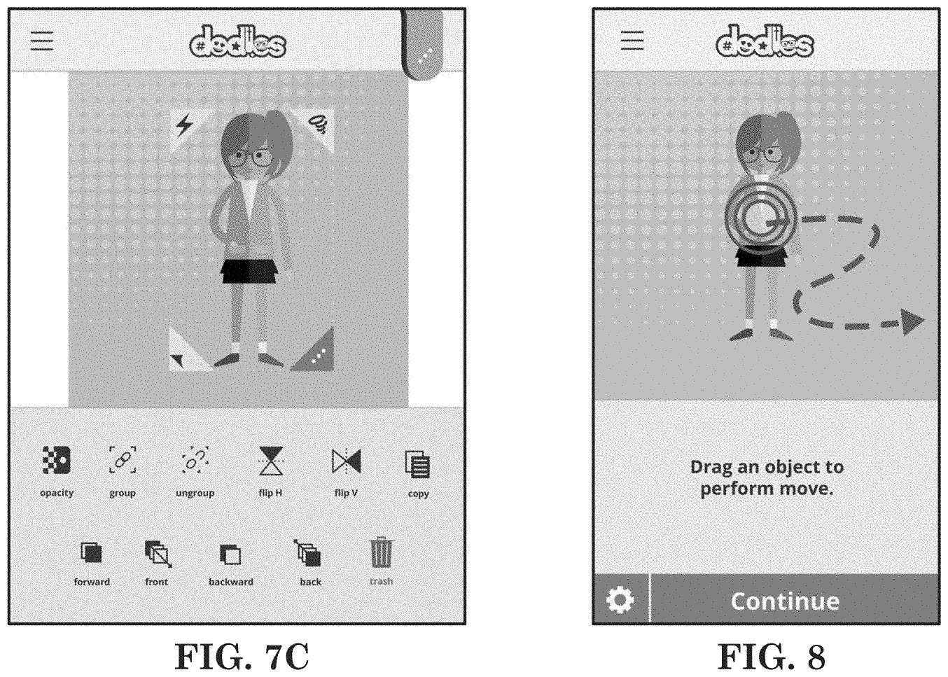

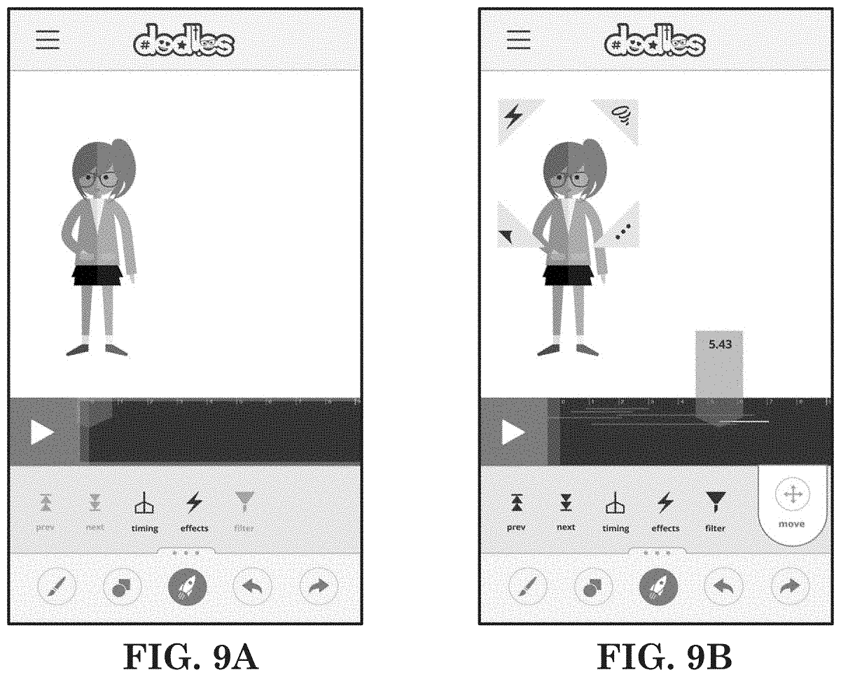

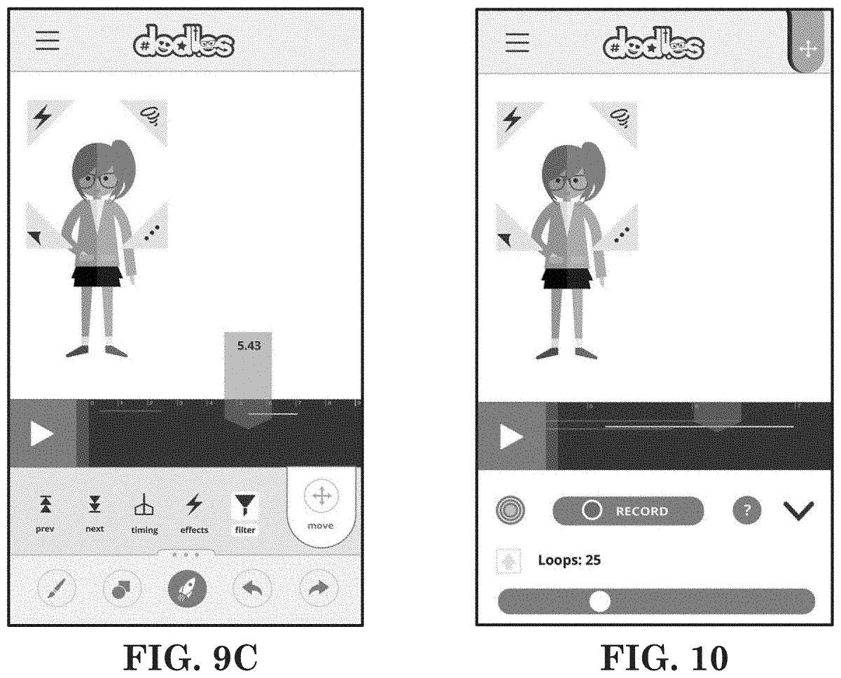

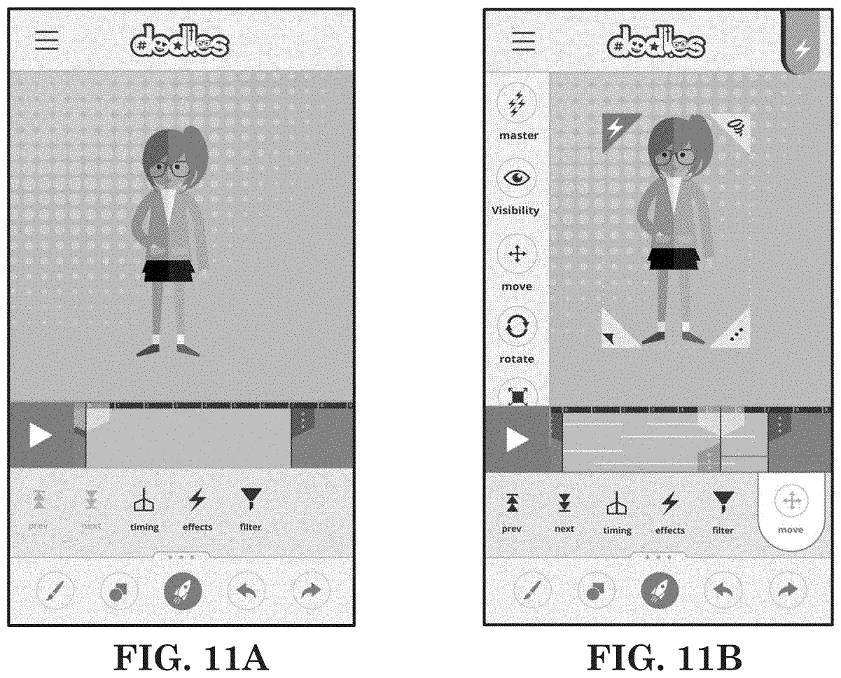

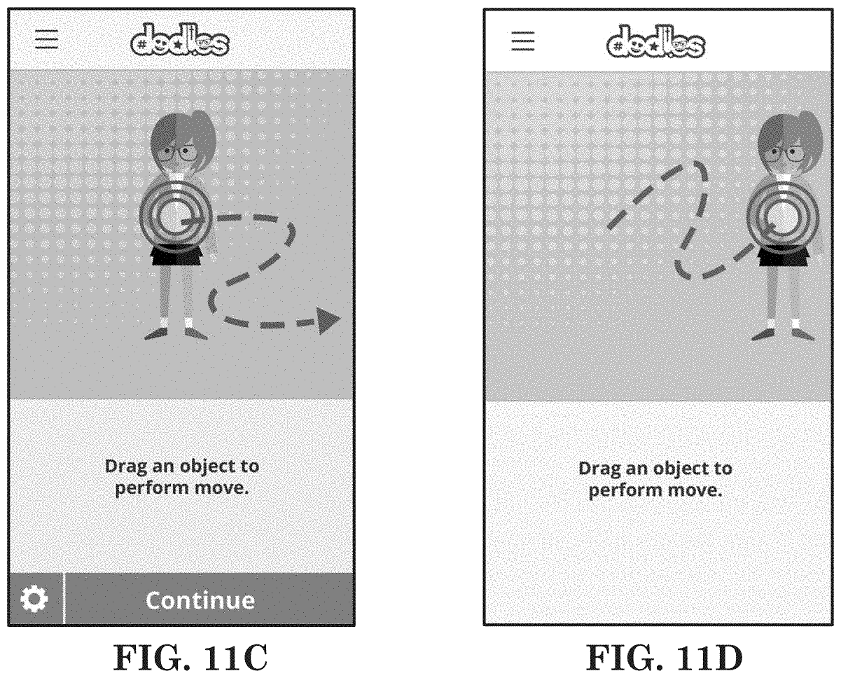

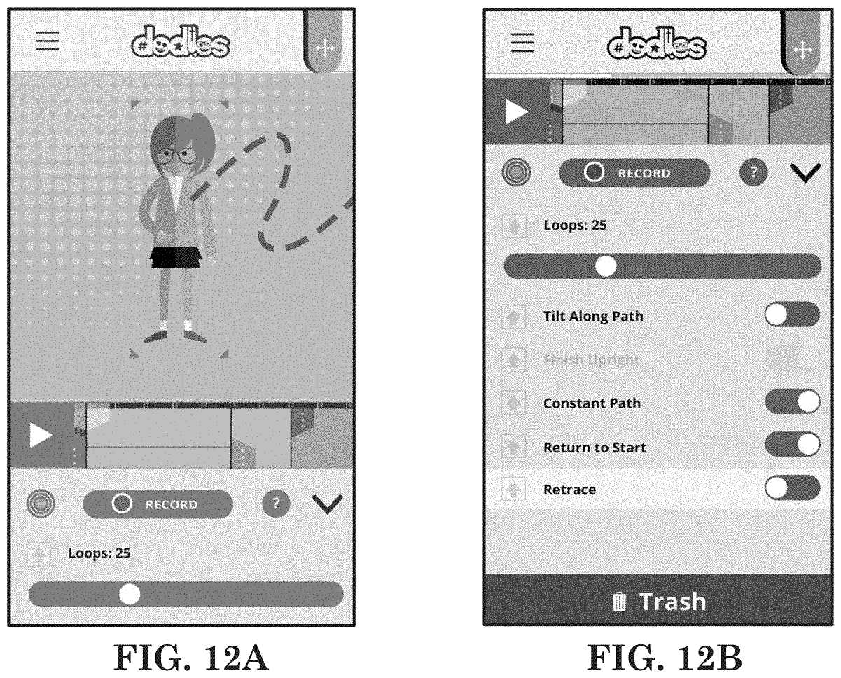

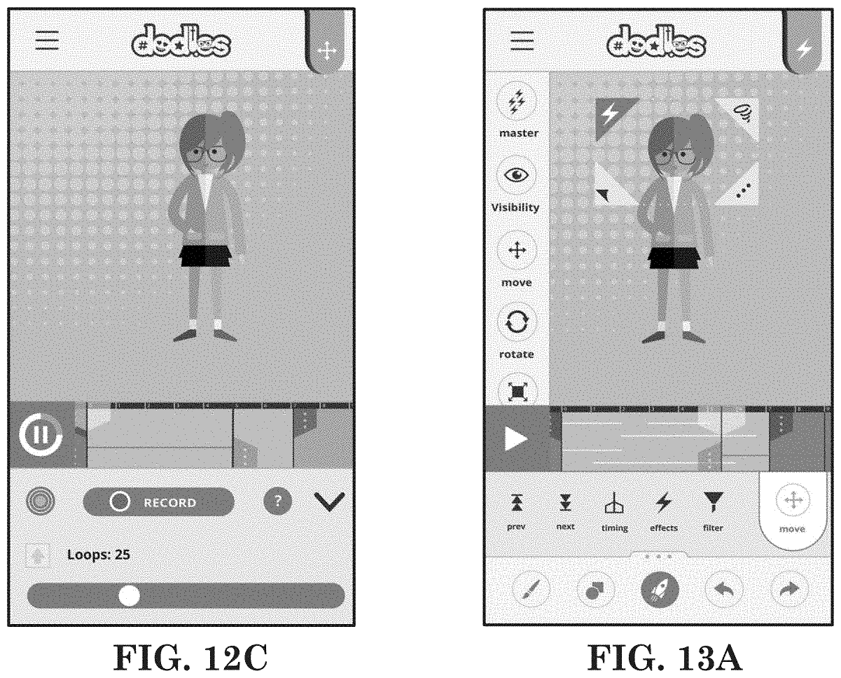

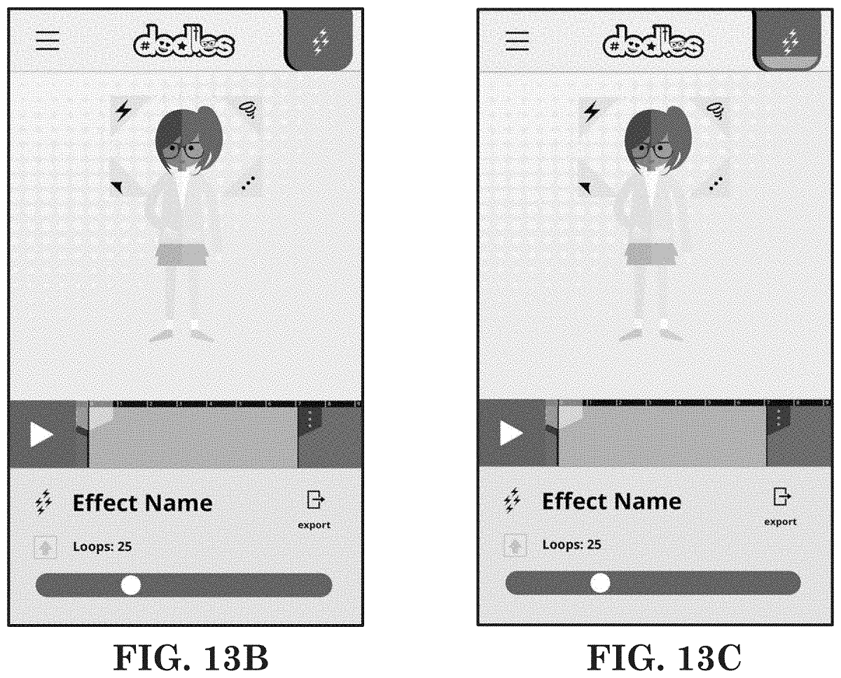

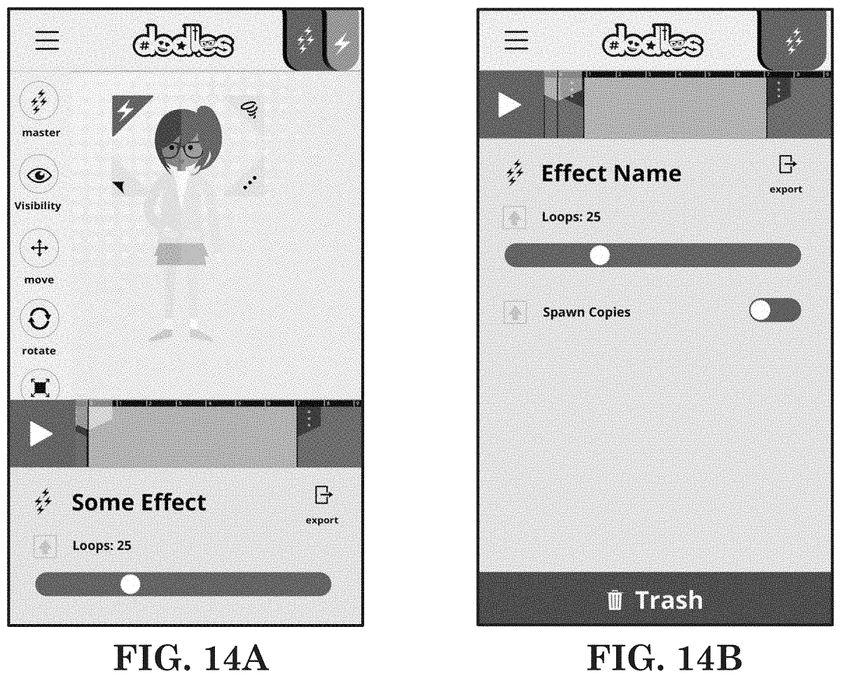

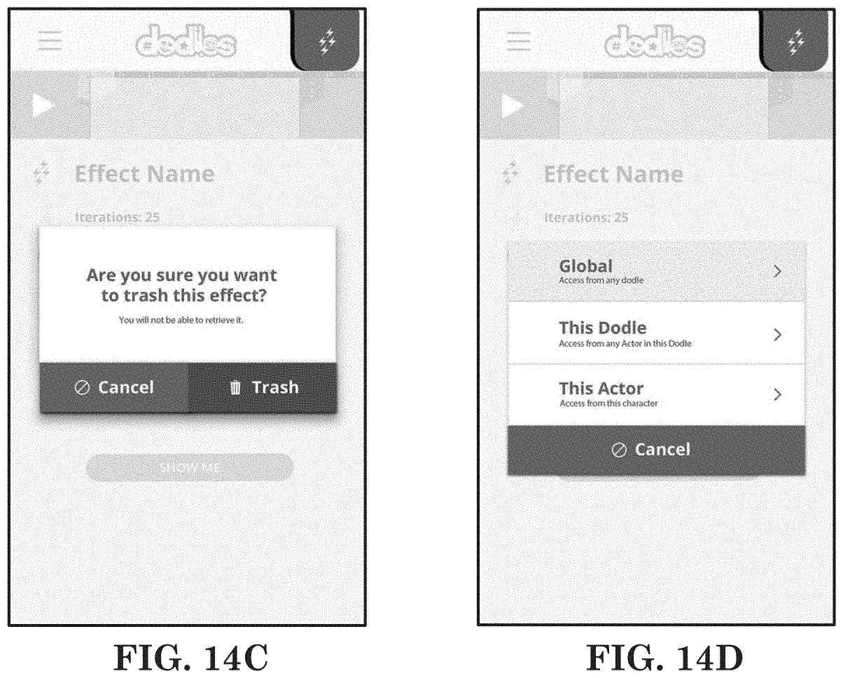

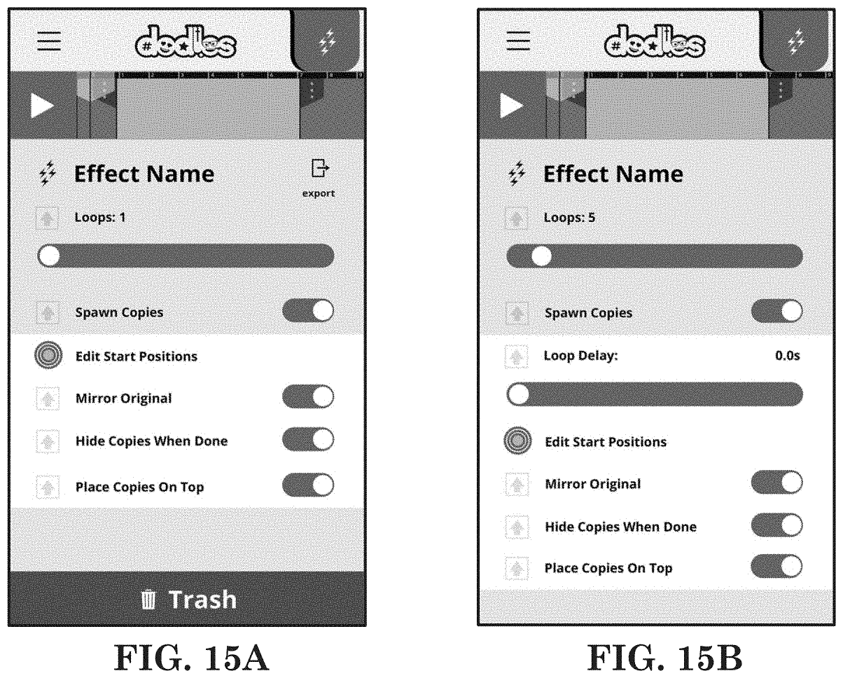

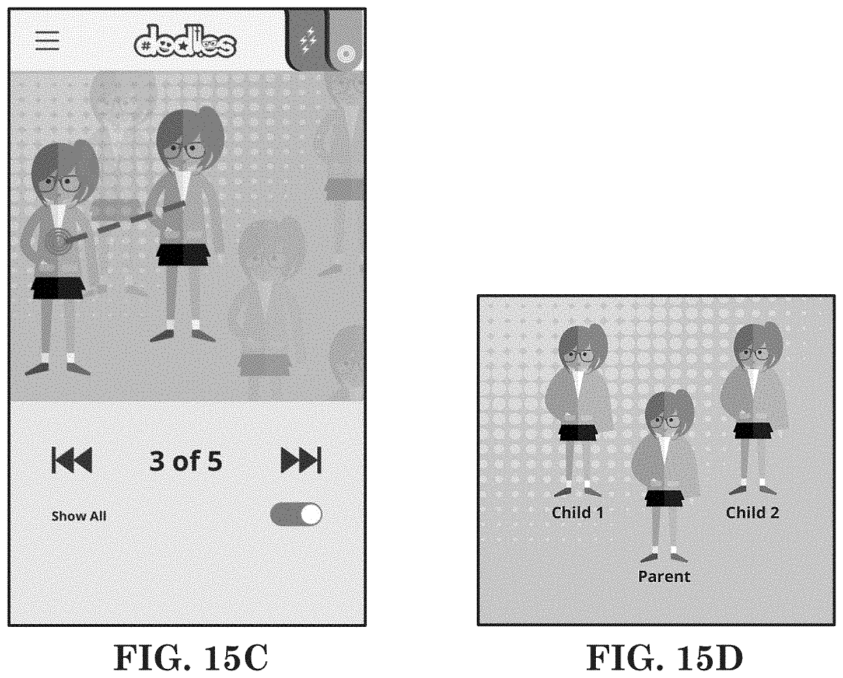

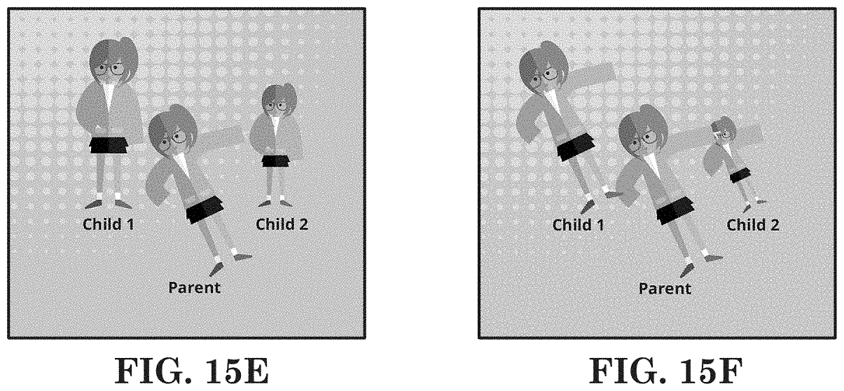

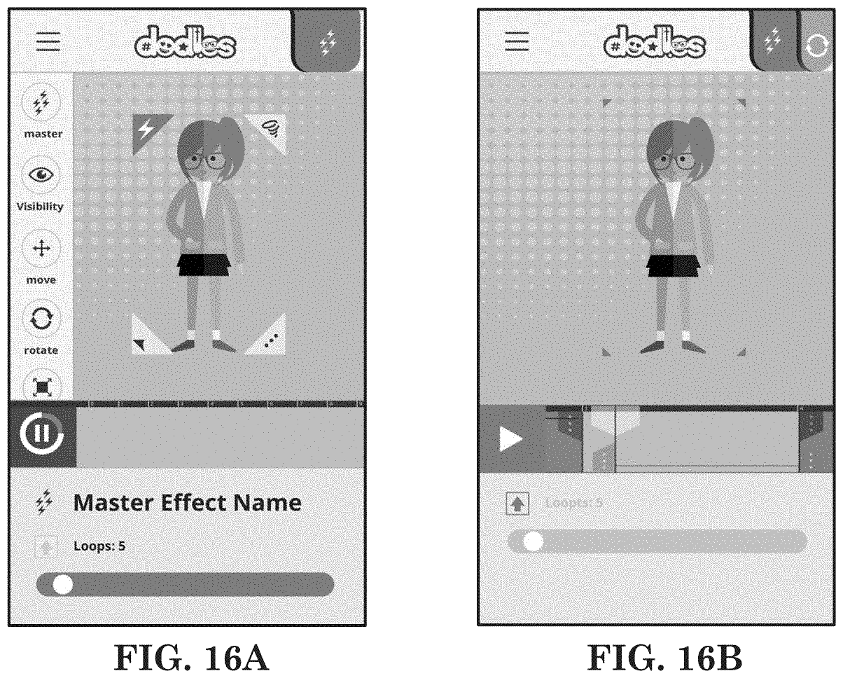

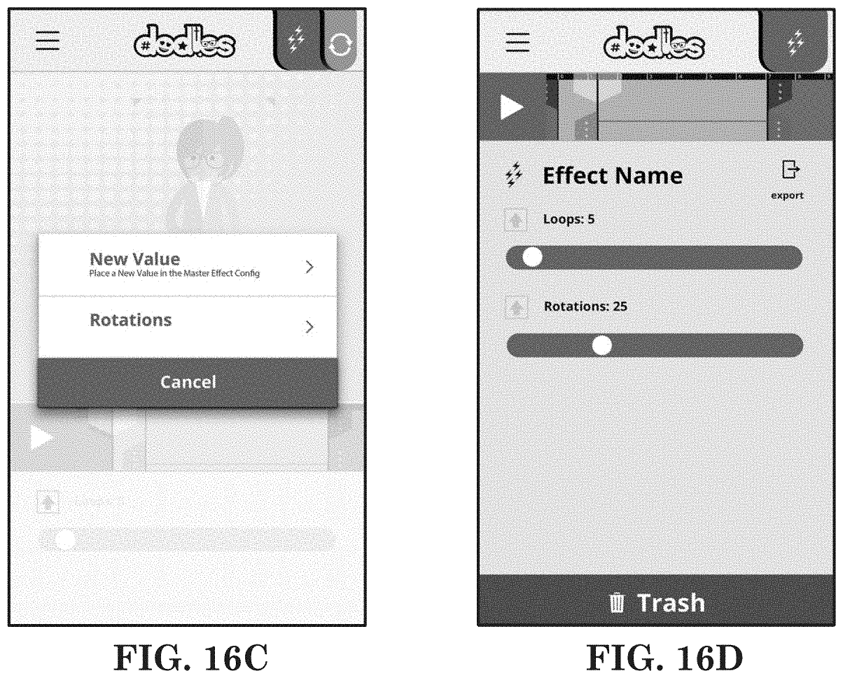

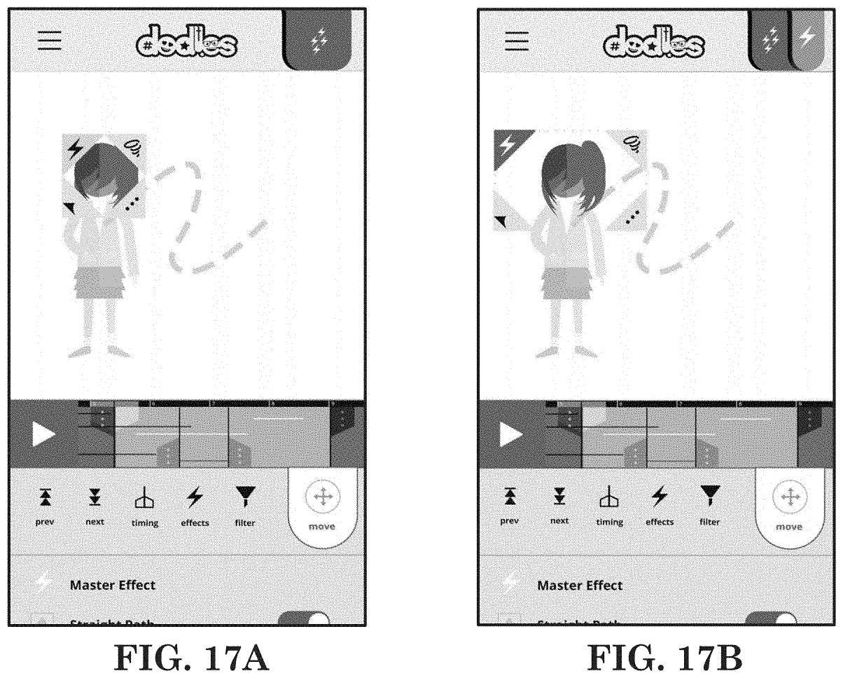

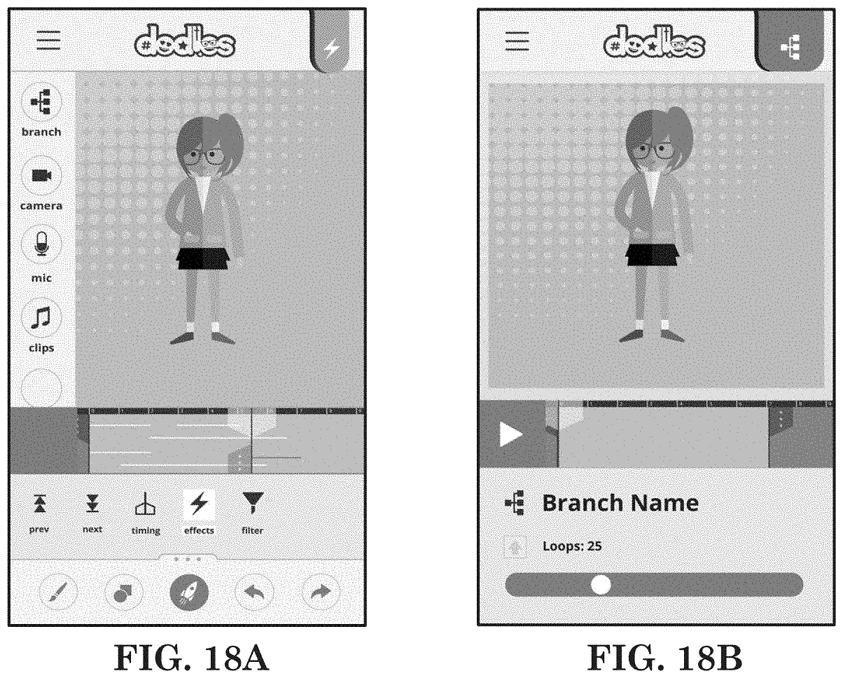

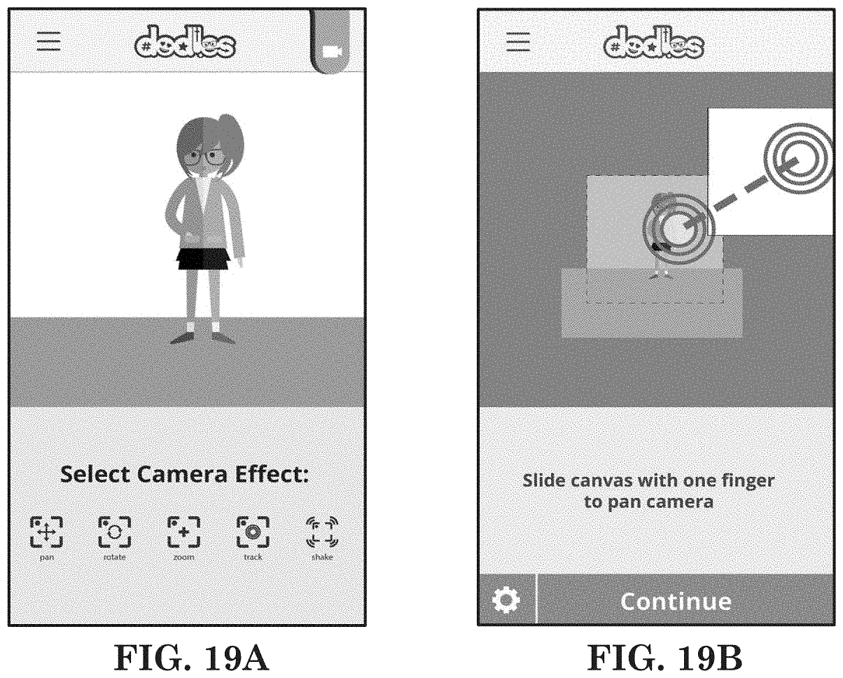

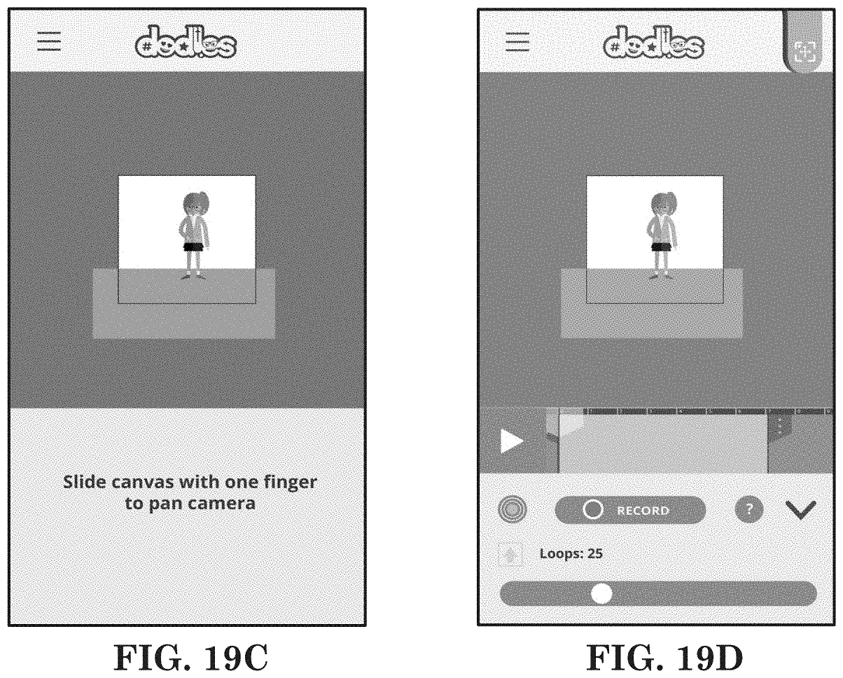

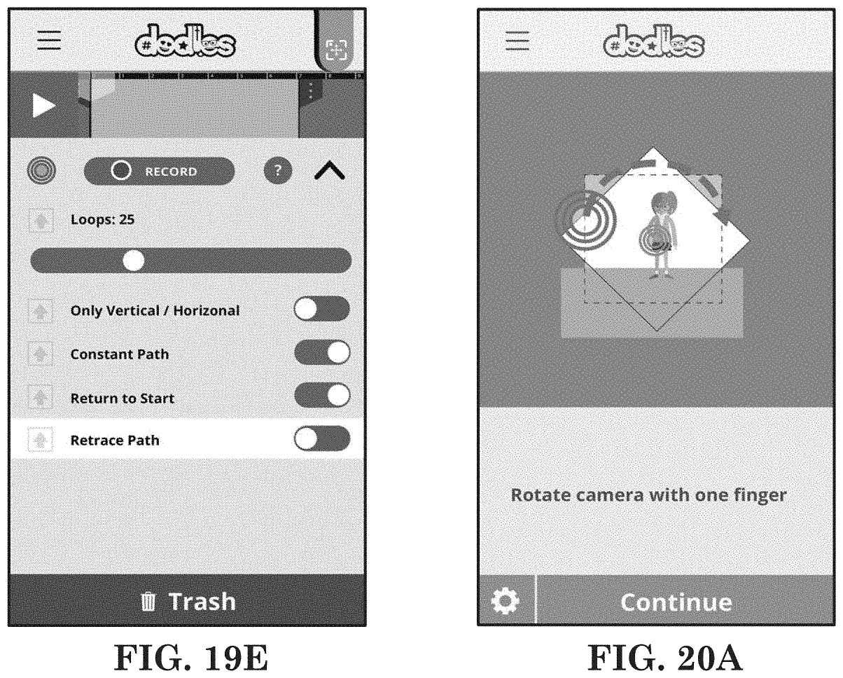

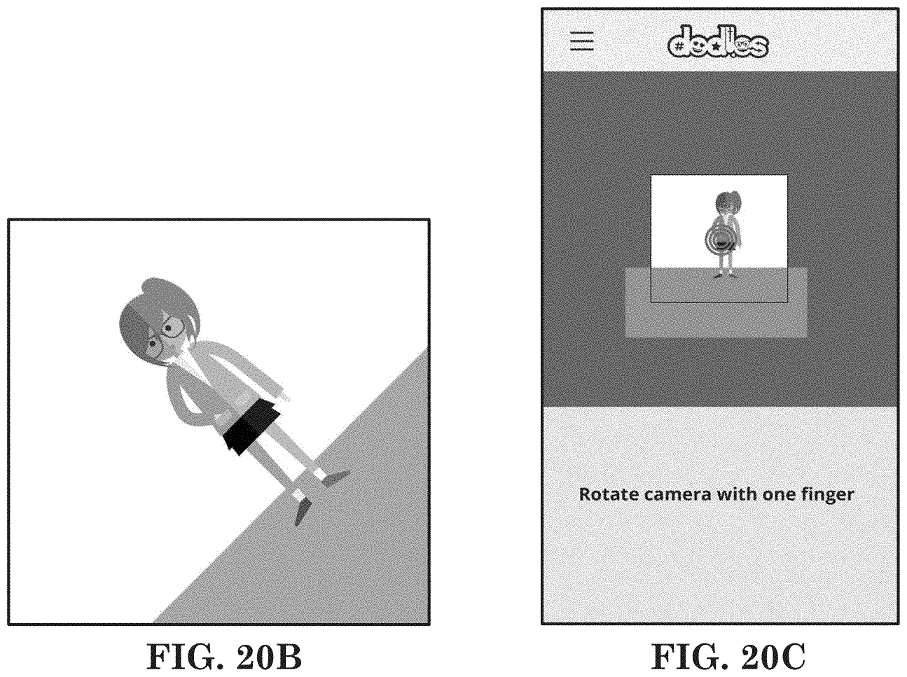

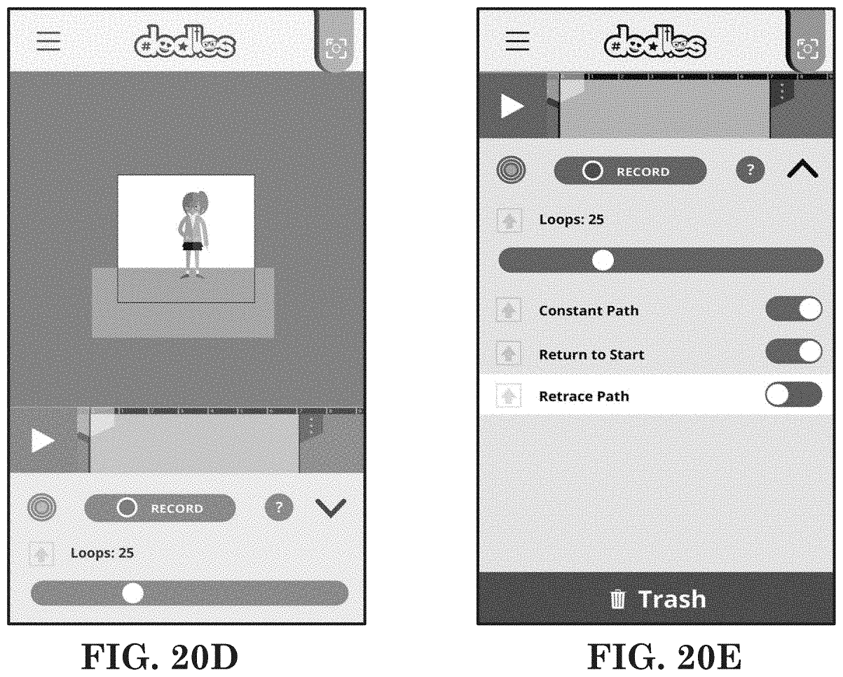

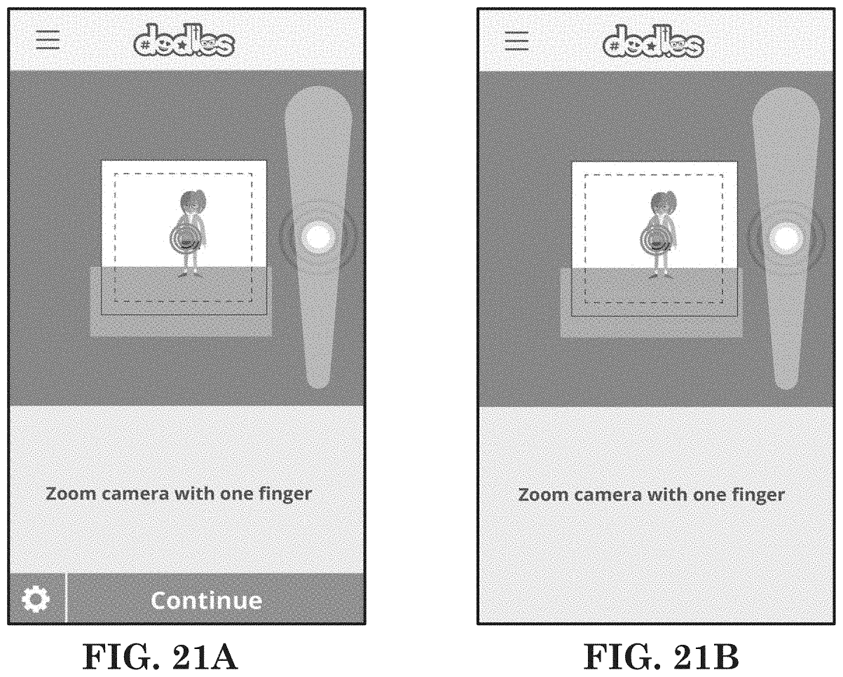

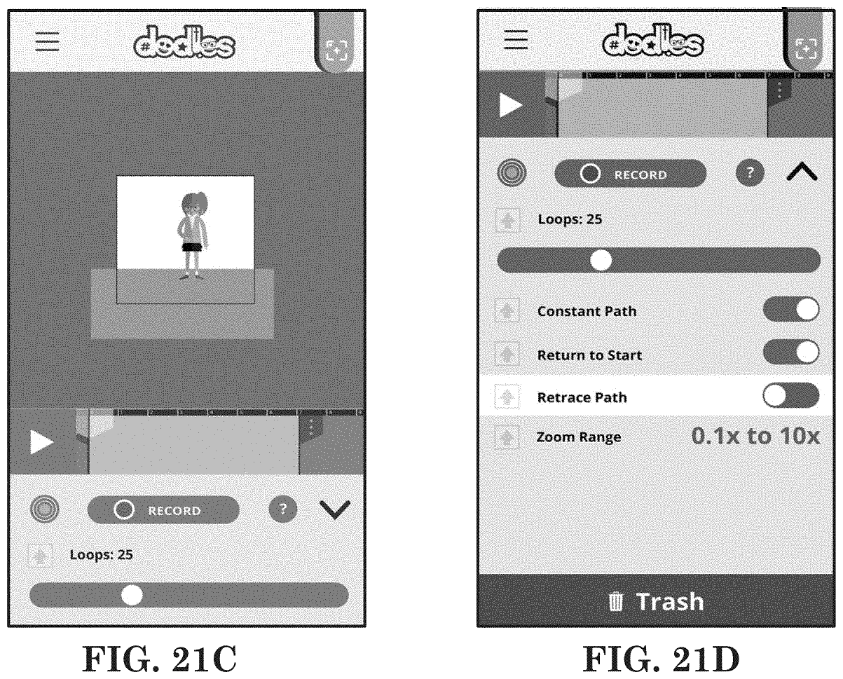

A “Timeline View” is shown in FIG. 5A. TIMELINE: in this view the user can tab through the effects to access and edit the effects and their timing. MINIMUM EFFECT LENGTH: even if an effect takes 0.0 seconds, the effect may still appear on the screen at a minimum non-zero size. By default and first implementation a 5 pixel length can be used to represent it on the timeline.

An “Object Effect Selection” is shown in FIG. 5B. OBJECTS EFFECTS: in the object effects view, the user loads a scrollable list of effects types, including Base Effects and Master Effects. The (scrollable) left bar is used for canimation effects, while the bottom section is for timeline manipulation and adding a scene effect.

A “Scene Effect Selection” is shown in FIG. 5C. SCENE EFFECTS: in the scene effects view, the user can select from overarching effects for the entire scene, including branch condition blocks, camera manipulation, recording from microphone, selecting an audio track, or swapping out screens.

An “Effects Configuration View” is shown in FIG. 5D. CONFIG: in the config view, users can manipulate properties of an effect, such as causing the software to tilt or rotate the orientation of a designated character as it moves along a predefined animation path (“Tilt Along Path”), or causing the character to move at a constant speed along such path (“Constant Path”), or causing the character to return to the starting point if the endpoint of the predefined animation path does not coincide with the starting point (“Return to Start”), or causing the character to retrace the predefined animation path backwards after it has traced the path completely in the forward direction (“Retrace Path”). The config view also includes a virtual RECORD button to allow the user to create a recording of position information as a function of time for later use in automated animation.

### Cross-Platform, Animation Views on Tablet

In the full animation view, on tablets users see the cropped drawing/animation area as well as an area outside the canvas they can use for staging objects ready for animation. When selecting an effect, the bottom object menu tray may cover the entire bottom section of the display.

A “Full Animation View” is shown in FIG. 6A. An “Effects Selection View” is shown in FIG. 6B.

### Cross-Platform, Additional Views

A “Configuration Options” tablet view, which includes a virtual RECORD button, is shown in FIG. 7A. A “First Time User Experience—Tablet” tablet view is shown in FIG. 7B. An “Options View—Tablet” is shown in FIG. 7C.

Throughout this document, First Time User Experience is abbreviated FTUE. FTUE/SHOW ME OPTION: the software may be configured to show an FTUE view or screen when (or only when) a user first applies a given effect on a given device, or when (or only when) the user clicks “Show Me” (see e.g. FIG. 11C below), or both. The software may otherwise be configured to skip FTUE views and screens. By skipping or omitting one, some, or all other FTUE views or steps disclosed herein, the software can operate in a more streamlined and rapid fashion to allow the user to define or carry out an animation effect or task with a minimal number of swipes, touches, clicks, or other user gestures or actions. For example, an animation effect or task may be defined or carried out by a user using only one, or only two, or only three such gestures.

### Fingertip Animation

A “Fingertip Animation” view is shown in FIG. 8. Two-dimensional (“2D”) digital animation falls generally into the categories of “frame-by-frame” animation, where the animator separately designs an entire image for each video frame displayed, and “motion graphics”, where images within the frame have various properties manipulated through a set of “keyframe positions”, saving time by allowing the animator to reuse content. “Character rigging” adds to the power of motion graphics, by creating even more flexibility that can be reused at the character level.

One limitation within all existing 2D animation is that the animator needs to manually adjust the timing and positions of the objects and characters being manipulated. With frame-by-frame animation, this happens by drawing out every single frame manually. Often there will be a simplified, rough draft attempt to achieve the desired timing sequence, and that is followed by filling in the details of every single frame.

With motion graphics, the motion between frames is achieved by moving or adjusting the attributes of an object from one keyframe position to another, and “tweening” or “interpolating” the frames for the objects between keyframes, often with the aid of a manual timing mechanism to modulate the rate of change between keyframes. The implementations of this to date result in limitations; physical attributes can only manipulated one sequence at a time, from keyframe position A to keyframe position B, and the timing (again between only those 2 positions) is entered manually and not with natural motions.

Fingertip Animation is a unique feature of the disclosed software to address these limitations on motion graphics, by measuring beyond keyframe A and B to any number of keyframe positions, and simultaneously measuring the timing as it reaches each keyframe position, using a single take “recording” of the keyframe positioning to control many changes in positions and timing.

The input device, such as a mouse, finger, or stylus, drags the object or representation of an object's attribute from one position to another over time, recording any number of attribute positions over time and saving it in memory as a time-based data file. This method can be applied to an object's base attributes, such as screen position, rotation, transparency/opacity, and size, but it can also be extended to the adjustment of most any attribute or effect or combination of effects, several examples of which are shown herein.

The actual recording process can be accomplished in a number of ways. In one example, the user may begin recording (after pushing the RECORD button) by touching the screen, and may stop recording by lifting his or her finger off of the screen. In another example, the user may click the virtual “RECORD” button to begin the recording, followed by any number of steps to manipulate the object that may require touching and lifting the finger, followed by an explicit “stop recording” click. In using this second option, the animator or the system can pre-determine if any recording should or should not take place while the finger is lifted.

When the recording is complete, the software may present to the user/animator many configuration options to manipulate the timing sequence further such as looping the sequence, reversing the sequence, trimming what is unnecessary, and adjusting or manually reconfiguring the timing to all or portions of the sequence. The software may also apply a positional smoothing curve or smooth out the timing without manual intervention.

The Fingertip Animation can be applied to any screen-output computing device, however, the benefits are clearly greatest when animating on a phone or tablet. The Fingertip Animation technique can also be applied to three-dimensional (3D) animation.

### Timeline Manipulation

With this feature, a user can navigate the timeline to access effects to move and edit them.

### Timeline

A “Basic Animation View-Inactive” screen is shown in FIG. 9A. Accessing “Animation” shows the timeline, along with some animation navigation functions. When no effects exist yet in the timeline as in FIG. 9A, some of these functions are inactive.

A “Move Playhead” screen is shown in FIG. 9B. With effects visible in the timeline, the user can tab through them using the “prev” and “next” icons. These icons can alternatively be designated “up” and “down”. When tabbing to the next effect, the movement of the timeline is preferably immediate, even if it takes longer (e.g. a short delay) for the canvas to render. The software preferably allows the user to quickly tab several effects up and down without having to wait for the canvas for each effect to render. When the user selects an effect, the effect turns white, and a white clip-shaped button appears on the screen to manage the effect settings. A 4-corner selection box wraps the object or sub-object connected to the selected effect. The line segments and gaps between segments should be kept as thin as possible to maximize space on the screen. The software preferably shows the next item up and down on the timeline. When the user gets to the last line at the top or bottom, they may scroll up or down to show the next item in the sequence.

The user may one-finger tap any location on the timeline to quickly snap the position of the playhead, while the finger is still pressed down and sliding. During this time, the marker extends outside the timeline (see FIG. 9B) so the user can see the precise position and time(s). The playheads and markers may be set to 50% transparency to view the underlying effect timing. All objects adjust to their respective positions for that point in time when the user releases the playhead.

A 2-finger pinch allows the user to zoom in or out to a bigger or smaller time window, originating from the point of zoom. A 2-finger swipe pans to another position on the timeline. When zooming, the distance between time segments shrinks/expands for effects and the measure line.

Each line segment represents an effect. Effects can be placed outside the begin and end boundary markers (denoted by the brighter shading), or straddling the start location like the 4^{th} effect. The smallest length an effect line segment can be is 3 pixels, even if it takes no elapsed time to complete, so that the effect remains visible.

The playhead will stop once it hits the scene's end marker and return to the start position, but the user can drag it out of bounds to play into the portion of the video that isn't part of the final scene. When playing from before the start, the playhead continues to the playable scene and removes the 50% overlay and does not pause at 0.

A “Filter” screen is shown in FIG. 9C. With an object or sub-object selected, the user can select “filter” to reduce the number of effects visible on the timeline to the level of that object and the effects of its own children objects. The effect order is maintained but the results are reduced. As the user tabs up and down to other effects, even the effects of children, the number of effects shown on the timeline remains the same, not re-filtering.

The user may tap the “filter” again to show the full list of effects, in the original order, maintaining the selected effect. The user can also tap and drag to multi-select, then “filter” to reduce the number of steps to those selected items. In some embodiments, the software may be configured to provide an indication that the filter is on, such as by temporarily reducing the visibility of objects that have been filtered out. The user may also choose the peel to hide an item temporarily. All of its effects and sub-effects are hidden from the timeline when peeled. When un-peeling, all effects may move back to their original location on the timeline.

### Timeline

A “Selected Effect” screen is shown in FIG. 10. Clicking on the white effect tab will edit that effect, bringing the user to this screen, What was previously highlighted now is centered and expanded in white to cover 75% of the timeline. The user can move the playhead by tapping or dragging a point along the timeline, and the zoom/pan features still apply also. The user may exit by tapping the OK stack at the upper right on the screen.

### Timeline Revisited

Here we revisit and compare a number of timeline-related features of the software, as follows:
Scrubbing timeline playhead—drag playhead, tap to playhead and how it can conflict with dragging the timeline itself to pan it. When the user drags his or her finger, the playhead location is not shown, however, in some embodiments, an adjusting numeric value for the time (e.g. in seconds) may be made to appear above the playhead.
Filter—when toggled on, this reveals all effects for the selected object and any sub-objects, However, when drilling further or accessing sub-object effects, further filtering may be omitted insofar as it may be disorienting to the user to follow what is going on with the timeline. The user can toggle the filter off to get the entire list, and can go back to re-filter at that level.
Trim Timeline—pull in endpoint markers to crop timing of the entire timeline. As marker is being dragged, reveal current position of objects on the canvas and then revert to the playhead canvas when complete.
Trim Effect—similar to trimming timeline but apply to effect. This may be the trimming of the base effect or the final “looped” effect.
Adjust timing—speed up any sequence between markers. The software may set the markers before or after the user selects this option. This feature may also be used to chop a segment. A slider may be used to lengthen and shorten timing of the segment, and it may apply to an entire timeline and to an effect. The base effect, the final effect, or both can be adjusted in this way.
Play segment—constrain play to a particular segment timing between markers so the user can see what segment timing looks like more accurately to allow the user to adjust without guessing.
Split—may be placed at the playhead or at the markers. The entire scene may be split into multiple scenes. An effect may be split into multiple effects.
Move segment—drag timing segment to a new timeline position.

### Applying & Editing an Effect

Examining the Move Effect: the Move Effect can be created in a few ways and has several options to automate repeating tasks.

### The Move Effect—User Applies Move

A “User Accesses Animate” screen is shown in FIG. 11A. The bottom navigation row has a highlighted “rocket ship” virtual button to indicate this is Animation Mode, which contains this Timeline View. ACCESSING ANIMATE: The user begins by accessing animate, i.e., the rocket ship virtual button, on the lower menu bar. In this example, no effects have been applied to this scene, demonstrated by the lack of line segments on the timeline bar, so prev and next are inaccessible as there are no effects to select. The user can squash and stretch (zoom in and out of) the timeline's length by dragging two fingers apart in the empty timeline in this view. The playhead is shown at position 0, referring to the seconds or some time segment on the timeline, when the user has no effects applied.

A “User Accesses Move Effect” screen is shown in FIG. 11B. ACCESSING THE EFFECTS PANEL: To access the effects panel, the user first taps an object and then taps the effects corner icon depicted by the lightning bolt (which activates or increments an OK stack). This can be accessed whether the user is currently in animate or not; however, once an effect button is pressed, the software takes the user to animate mode. SELECTED: pressing a specific effect triggers its selected state. The panel slides off to the left.

The software can also be configured to reduce the selection of an effect down to “one click animation” by immediately presenting a list of effects on the screen when first selecting the object from within Timeline View. In such configurations of the software, all FTUE screens disclosed herein would preferably be omitted. The effect list may be placed below the timeline in the bottom two rows of the screen, and the user could immediately select and apply the effect of choice from there with just one click, touch, or gesture.

An optional “Effect Prompt Animation” screen is shown in FIG. 11C. This is an example of an optional FTUE or “Show Me” screen or prompt. As such, if it is included as a feature of the software, this prompt is only seen by users whom have never used the effect and disappears by pressing continue. If the user has seen this prompt before, or if FTUE screens are omitted, the process flow may immediately skip to the screen of FIG. 11D. DESCRIPTION PROMPT: once an effect is triggered, a brief description prompt fades in. This shows an animated “demo” of the effect with a placeholder object and describes how the user can create the effect, cycling through until the user hits the virtual continue button at the bottom of the screen. In the example of FIG. 11C, the prompt is for the Move Effect, and thus it assumes the user has chosen the Move Effect for the first time.

The effect's start time begins wherever the playhead was on the timeline when the effect button was pressed, in this case 0.

Another optional “Effect Prompt Animation” screen is shown in FIG. 11D. The user is prompted to drag the character along the desired path. The user can optionally first zoom in or out of the canvas camera with a pinch motion to ensure the drag can cover the desired range of motion.

The spot that the user selects on the character to drag from becomes the axis point for the motion. DRAG START: Once the user begins dragging the character, a line stroke trail may follow behind to demonstrate the path of motion, and the character may move as the user drags it. The path and timing may be recorded so that with a single recorded motion, the user can intuitively set or program both the timing and movement of the object over a specified time period, without the need for additional timing and path manipulation. However, the user can optionally tweak (modify) the path of motion manually using path vertices and handles, and can similarly manipulate timing further with preset or manual timing curves.

Upon releasing from dragging the character (e.g. lifting up the finger off the character), recording is stopped and the user passes on to the configuration menu and sees the character in its initial position, but with a line stroke representing the path of motion, as seen in FIG. 12A.

### The Move Effect—User Configures Move

A “Configure Effect” screen, which includes a virtual “RECORD” button, is shown in FIG. 12A.

The timeline depicts a begin and end effect marker flanking the selected effect that has been added to the timeline. Here, the user can drag the left bound manually to adjust start position and right bound for time length/end point used to cutoff or extend an effect. The user is able to drag the end point past the end marker for the timeline, even though it will cut off as it plays. This will have the impact of starting or ending in mid-animation, as opposed to having all animations transitioning in and out. The lower part of the screen is scrollable, but not the drawing canvas.

CONFIGURE EFFECT MODE: during effect creation, the beginning and end markers of the overall timeline may become immobile to keep from overlapping input on the timeline (and as such are depicted in low opacity in FIG. 12A), while the user can access the handles for the beginning and end of effects. The timing will minor the finger motion, but can be scaled, i.e., sped up or slowed down uniformly. The newly applied effects handles flank the 1 pixel blue effect time bar.

In this regard, thicker or thinner handles may alternatively be used. OK STACK: clicking the OK Stack (the green virtual button near the upper right corner of the display in FIG. 12A) closes out the configuration options menu, taking the user back to the Object Menu/Effects (see FIG. 11B) select mode with the timeline set to the end of the last effect, where the user can quickly add another effect or hit OK Stack again to back out. The user can also change the end points of the animation timeline if they exit out of the screen of FIG. 11B.

Alternative embodiments of the software may include additional configuration options such as preset and custom speed curves which allow the user to manipulate the ease in/ease out properties of an effect's motion, but this is not shown in the figures. The preset curves could be represented with simple icons depicting the shape of the curves.

To the left of “Loops” in the screen of FIG. 12B is an Up arrow that is disabled (indicated visually by low opacity), because this effect does not have an active Parent “Master Effect” that encapsulates it, but the Up arrow is nevertheless shown in the figure for consistency. When activated, a Child Effect will pull or take this value from its Parent (Master). The Master Effects feature is one that allows a plurality of effects to be used in conjunction with its own timeline to create larger combination effects. Master effects properties may thus be reused and combined across its children.

The virtual RECORD button brings the user back to a state of dragging the object (see e.g. FIG. 11D) to replace the movement stroke. If the user makes an upward sliding gesture anywhere from the bottom menu section (including the timeline) or clicks the downward “v” arrow, the software will reveal more configuration options. As the user scrolls up, the timeline locks into place at the top, so that it is always visible. Scroll back down to lock back along the bottom.

IMPLIED MOVE EFFECT: from FIG. 11B, drag the character around and release to complete, recording the movement as if the Move effect had been chosen. User sees a screen such as that of FIG. 10, and can configure the effect or continue to drag the character around to add another effect, and so on. There is an implied OK click to complete these effects if the dragging continues. This method allows users to add a number of consecutive complex movements quickly on the timeline by only performing a series of hand gestures or other singular motions with input devices.

Another “Configure Effect” screen, containing a virtual RECORD button, is shown in FIG. 12B.

LOOPS: this cycles through the motion (including reverse) a multiple number of times. Moving the slider to the right end sets it to “infinite” loops, or a very large number unknown to the user, which is especially helpful for game development or for a rapid ongoing shake motion in a longer scene. In some implementations, this motion may get cut off at some point either by a parent Master Effect, the end of the scene, or the end of the animation.

TILT ALONG PATH: this feature refers to controlling the object's orientation so that it always stays upright or adjusts to remain parallel to the path angle. When activated, the user can choose to Finish Upright (only selectable when Tilt is activated).

STRAIGHT PATH: this feature ignores the user's manual path and timing, and instead uses a straight line from start point to end point of the user's motion.

RETURN TO START: this feature places the object back at the beginning when finished with an effect loop. If selected, Reverse Motion becomes available.

RETRACE: this feature simply mirrors the entire motion, duplicating it in reverse back towards the initial position at the same speed. This option slides visible if “Return to Start” is selected. A “Show Help” button at the bottom of the Configuration Options screen brings up the optional FTUE animation or prompt from FIG. 11C.

A “Playing Animation” screen is shown in FIG. 12C. Touching or clicking the play button moves the bottom tray back into position and the play button turns into Pause. While in play mode, the other functions are inaccessible, except pausing or moving the playhead.

### The Master Effect

The Master Effect feature allows the user to group other effects together to make animation more manageable. The Master Effect also allows users to create, distribute, and even license custom effects to speed up the process and reduce repetition, while also simplifying by organizing effects into smaller, more manageable chunks or segments of time.

### Add Master Effect

An “Add Master Effect” screen is shown in FIG. 13A. From the Effects Menu, Select “Master” to create a Master Effect for the selected object at the given point on the timeline.

A “Configure Master Effect” screen is shown in FIG. 13B. Clicking “Effect Name” brings up the keyboard to edit the name. The effects appear below the timeline, and can swipe up for an accessible list of them or hit play to see the effect in action or move the sliders to adjust timing. Nothing will happen at this point, since no effects are included.

Another implementation of this may use “prev” and “next” buttons on a row immediately beneath the timeline to tab through the effects and then select the white button to edit the particular effect options.

The tab at the top of FIG. 13B (i.e., the wide virtual button tab near the top right corner of the display) represents the time stack. This tab, which may be blue, works in similar fashion to the smaller OK stack, but the OK stack works on top of it, so the user can tap the blue time stack to exit everything including the OK stack. We remain drilled into the character or object, but we don't need to maintain the OK stack drill level considering we are already limited to objects tied to the master effect, in this case the head of the character. The Master Effect is already created immediately without confirming it, allowing us to continue adding effects to the Master Effect timeline or configuration. It acts as if we have a completed effect and have now drilled into it and begun editing it.

To add a child effect, drill further into the character, or stay at this level and click the lightning bolt. NOTE: this is now a sublevel timeline, not the original timeline. We have “zoomed in” and can only access the object associated with the master effect. All timeline elements are only for this effect and its children.

A “Child Master Effect View” screen is shown in FIG. 13C. Master Effects can be nested within each other like someone would nest grouped objects, and that adds levels to the time stack, depicted by the bar on the upper right button.

### Base Setup

A “Drilling Into Object” screen is shown in FIG. 14A. Drilling into the object preserves an exterior time stack tab (wide blue virtual button tab near the top right corner of the display) to exit completely while the green OK stack (narrow virtual button tab overlaying the right-most portion of the exterior time stack tab) lets the user work through the object layers to add more effects to a particular object or sub-object.

A “Default Config Options” screen is shown in FIG. 14B. Scrolling shows off all current options for the Master Effect. Other implementations may include the ability to upload or select an image for easier identification of the effect when saved or exported or licensed. Double-Clicking Effect Name brings up the keyboard to edit the name. By default, these options are available. More options will appear as its child effects signal that they are expecting to pull data from their parent/master as further described below. Export allows the effect to be saved for reuse and applied to other objects.

A “Trash Modal” screen is shown in FIG. 14C. If trash is selected, a confirmation modal appears here, like we already use elsewhere, but allows the user to remove an individual effect. An “Export Modal” screen is shown in FIG. 14D. EXPORT: this Modal allows users to choose where they can all access this new master effect. When the user chooses an option, another modal appears to confirm the name of the effect.

### Spawn Copies

A “More Options for Copies” screen is shown in FIG. 15A. SPAWN COPIES: when selected, this triggers the opening of options to manage the individual copies, as these effects apply to the copies. If Loops are set to 1, Loop Delay slider is hidden. “Hide Copies” cleanly depreciates these copies when the animation completes. “Copies on Top” sets each new copy on the next layer above the original and last.

A “Loop Delay” screen is shown in FIG. 15B. LOOP DELAY: when Loops are greater than 1, a slider appears to allow users to adjust timing between instantiation of the next loop. There are overlapping copies occurring simultaneously by default, but the timing can be spaced out by tenths of seconds.

A “Change Start Positions” screen is shown in FIG. 15C. By default, copies spawn from the position of the original. Selecting “Edit Start Positions” by tapping the target icon allows us to cycle through each loop (copy) and select a new starting location for each to spawn from.

If there is only one copy, the cycle options at the bottom of the screen do not appear. Tapping anywhere on the screen will move the currently selected copy to that spot, or the user can also drag the item. The user may then tab left or right to access the next copy, exiting by clicking OK. Note that these positions are relative to the original object. So, if the parent object moves, the next copy spawns relative to that new position. The spawned objects are then disconnected from the original, unless “Mirror Parent” option is selected. Copies spawn on the same layer as the original, just above or below, depending on the “Copies On Top” toggle.

With “Show All” selected, all copies are visible, with the current selection and original at 100%, and the others at 20%. This can be noisy when the count is high, so it can be helpful to toggle off, but normally it can be useful to see where the copies appear relative to each other. In some embodiments, the software may allow users to use 2-finger rotate and resize, allowing for some added, controlled variation. Random variations can also be introduced through added variable effects within the Master Effects timeline, such that the start positions are randomized.

MIRROR PARENT: refer to FIGS. 15D through 15F. FIG. 15D illustrates the initial positions of the original and two child copies. FIG. 15E illustrates that when “Mirror Original” is deselected, the original and its component (drilled) effects do not affect child objects, which are only being directed by the Master Effect. FIG. 15F illustrates that when “Mirror Original” is selected, the original and its component (drilled) effects are also applied to copies. The children (copies) have the Master Effect's effects also applied, so they will not necessarily be exact replicas.

### Add Child Effect

An “Add Child Effect to Master” screen is shown in FIG. 16A. Master Effects can have multiple attached child effects that together form a bigger effect. The user is restricted to the highlighted object that is attached to the Master Effect or a sub-Object.

A “Configure Child Effect” screen is shown in FIG. 16B. Configure the Child Effect, in this case, Rotate. Note that the up arrows are now active, allowing the values to be pulled from the Master when selected. Doing so makes the current selection inactive, but the user can see what value is being pulled down from the Master. The name in parentheses is the corresponding parent name. The 4-corner menu is inactive as the user configures the spin effect.

A “Push Config Toggle” screen is shown in FIG. 16C. Pulling a child value up from the Master results in a dialogue box, allowing the users to choose from an existing value or create a new one. If a new one, the user has the opportunity to name it, to avoid confusion with conflicting fields.

A “Master Config After Push” screen is shown in FIG. 16D. The Master Config now contains fields for Rotations, since the Child Effect has activated pulling it. Modifying these values control the values of any attached children (copies).

### Timeline Drilling

A “Drilling Into a Master Effect” screen is shown in FIG. 17A. A blue “time stack” appears (see the upper right corner of the screen) representing having zoomed into an effect or block, and is somewhat separate from the green OK stack. Clicking the button closes out the editing of that effect and returns to the previous screen. If an effect has sub-effects and the user continues to drill further into the timeline, it will increment the number of light bars on the stack to represent the number of currently open branched tasks.

Drilling into a Master Effect is similar to FIG. 13B, and the user has the opportunity to access nested effects within that effect, in addition to configuring the Master Effect controls.

This timeline is zoomed in but acts much like the original timeline, with the outer boundaries now being the Master Effect time constraints and the inner boundaries for each accessed child effect the user has tabbed to, using Previous and Next. Scroll up to access the configuration options for the Master Effect, click the white tab to drill into the child effect, and the upper right (blue) tab to exit.

A “Drilling Into an Object” screen is shown in FIG. 17B. While in any timeline mode, the user can simultaneously drill into pertinent objects. If an effect is tied to an object and the user drills into that effect, the user can only access that object or its sub-objects. A separate stack is maintained for object drilling (narrow green OK stack) and time drilling (wide blue time stack).

### Scene Effects

With this feature, a user can apply an effect to an entire timeline. Scene effects apply to the entire timeline, in contrast to object effects, which apply only to a particular object.

### Add Scene Effect

A “Scene Effect Selection” screen is shown in FIG. 18A. SCENE EFFECTS: in the scene effects view, the user can select from overarching effects for the entire scene, including branch condition blocks, camera manipulation, recording from microphone, selecting an audio track, or swapping out scenes.

A “Branch Effect Configuration” screen is shown in FIG. 18B. BRANCH EFFECTS: Branch Effects are to a Scene what Master Effects are to an Object. Branch Effects are capable of aggregating any number of effects, which can be helpful for organizational purposes or for gaming-type logic.

ORGANIZING: rather than post a large number of effects to a single timeline, the user can break this out into smaller subroutines, through these branches. These branch routines can also then be looped as a single repeating set of effects. The resulting effect sequence then appears as a single item on the original timeline.

CONDITIONAL LOGIC: one of the key powers of branching is to set up gaming logic. By adding conditions to a branch, branches can be set up with listening periods, acting as windows of time for conditions to be met. These conditions can be further nested as combined conditional logic for this branch and as subroutine child branches. A white edge border or the like can be used to reinforce the concept that the effect applies to the scene.

### Camera Effects

Pan, Rotate, Zoom, Track, Shake. Effects such as these can be mapped out with a square canvas, but alternative canvas sizes and shapes, e.g., rectangular or otherwise non-square, can also be used so as not to be boxed in.

### Camera Effects: Pan

A “Camera Effect Selection” screen is shown in FIG. 19A. SELECT CAMERA EFFECT: in the scene effects view (e.g. after selecting camera in FIG. 18A), the user can select from overarching effects for the entire scene, including branch condition blocks, camera manipulation, recording from microphone, selecting an audio track, or swapping out scenes. The user may exit back to Animation Mode by clicking OK.

A “FTUE Pan DEMO” screen is shown in FIG. 19B. FTUE DEMO: shows the user that dragging the canvas block is what moves the (virtual) camera. The front black frame and back white canvas drag with the user's finger, while the scene objects remain stationary. The demo canvas preferably takes up no more than 1/9 of the space. In the depicted example, the green grass is between the canvas background and frame. If the green grass covered beyond the canvas, the user would only be able to sec the overlay frame. Actual recording may employ a similar screen without the continue button. The canvas may be zoomed to 1/9th by default, unless the user has already shrunk to ¼ size or smaller.

A “Record Panning” screen is shown in FIG. 19C. RECORDING MODE: from the recording screen, the user can 2-finger zoom and pan prior to recording. If coming from the configuration screen, the camera should not be reset to 1/9 frame a second time. When 1-finger touch begins, recording starts, and completes when the finger lifts from the touch screen. A recording icon may also be added to these screens in the upper left or near the instructions.

A “Configure Panning” screen is shown in FIG. 19D. PAN CONFIGURATION: if a user taps in FIG. 19B, they come directly to this screen without recording, allowing them to set up configuration first. Tapping “?” brings them to FIG. 19B. If the user taps “Redraw Path”, recording begins. The green OK icon should be tapped to exit or complete.

A “Configure Panning-Continued” screen is shown in FIG. 19E. These are similar options to those of the Object Move effect. The “Only Vertical/Horizontal” toggle locks pan motion up/down and left/right. The decision between horizontal and vertical occurs during recording, adapting to general direction of user input and locking the direction, similar to holding the SHIFT key in desktop applications.

### Camera: Rotate

A “Rotate FTUE Demo” screen is shown in FIG. 20A. FTUE DEMO: this shows the user that dragging the canvas block is what moves the (virtual) camera. In the depicted example, the grass is between the canvas background and frame. If the green covered beyond the canvas, the user would only be able to see the overlay frame. Actual recording may employ a similar screen without the continue button. The canvas may be zoomed to 1/9th by default, unless the user has already shrunk to e.g. ¼ size or smaller.

A “Rotate FTUE Demo—Results” screen is shown in FIG. 20B. This is how the prior screen (FIG. 20A) appears when played at the reference point in the previous screen.

A “Record Rotate” screen is shown in FIG. 20C, RECORD MODE: from the recording screen, the user can 2-finger zoom and pan prior to recording. If coming from the configuration screen, the camera should not be reset to 1/9 frame a second time. When 1-finger touch begins, recording starts, and completes when the finger lifts from the touch screen. A recording icon may also be added to these screens in the upper left or near the instructions. Rotating the camera (frame of view) with one finger can be accomplished by touching any point on the canvas background (outside of the centrally located box or frame) and dragging the touch point in a clockwise or counterclockwise direction at any desired speed or range or combination of speeds, and combinations of clockwise and counterclockwise motions, e.g., alternating clockwise and counterclockwise motions (e.g. to simulate rocking back and forth), can also be done. The bullseye pattern that can be seen in FIG. 20A defines the pivot point about which the rotation(s) will occur. The position of the bullseye pattern, and thus the position of the pivot point, can be changed by touching the bullseye pattern, dragging it to another location on the screen, and lifting the finger off of the screen at the new location.

A “Configure Rotate” screen is shown in FIG. 20D. ROTATE CONFIGURATION: if the user taps the touch screen in FIG. 20A, they come directly to this screen without recording, allowing them to set up configuration first. Tapping “?” brings them to FIG. 20A. If the user taps the virtual “RECORD” button, recording begins. The green OK icon should be tapped to exit or complete. Reset the frame to 1/9th if the size is greater than ¼ the screen and if this is the first time accessing this screen in a sequence.

A “Configure Rotate—Continued” screen is shown in FIG. 20E. These are similar options to those of the Camera Panning effect. The “Constant Path” option establishes a constant rate of rotation from the start position to the end position, with no counter-rotations. The rotation direction is established at the start of user movement and Retrace will go in the opposite direction and as with other effects, but is only available when the “Return to Start” feature is activated.

### Camera: Zoom

A “Zoom FTUE Demo” screen is shown in FIG. 21A. FTUE DEMO: this shows the user that dragging the slider (the large bullseye pattern on the right side of FIG. 21A) resizes the canvas. In the depicted example, the grass is between the canvas background and frame. If the green covered beyond the canvas, the user would only be able to see the overlay frame. The software is configured to resize the canvas (frame) larger or smaller as the user drags the large bullseye slider up or down (respectively) on the elongated portion of the screen reserved for this purpose. This resizing or zooming of the canvas is carried out with respect to a stationary reference point defined by the smaller bullseye pattern (blue dot) in the center of Fla 21A. The location of the stationary reference point can be moved by touching it, dragging it to another location on the screen, and lifting the finger off of the screen at the new location. Actual recording of the zooming motion of the canvas may employ a similar screen as FIG. 21A but without the continue button. For purposes of this feature the canvas may be zoomed (resized) to 1/9 th by default, unless the user has already shrunk (resized) it to e.g. ¼ size or smaller.

A “Zoom Recording” screen is shown in FIG. 21B. ZOOM RECORDING: from the recording screen, the user can 2-finger zoom and pan prior to recording. If coming from the configuration screen, the camera will not be reset to 1/9 frame a second time. When 1-finger touch begins, recording starts, and completes when the finger lifts from the touch screen. A recording icon may be added to these screens in upper left or near the instructions. The slider range may be from 10% to 1000% (i.e. 0.1× to 10×) by default, but other upper and lower limits may also be used.

A “Configure Zoom” screen is shown in FIG. 21C. ZOOM CONFIGURATION: if the user taps the touch screen in 21A, they come directly to this screen without recording, allowing them to set up configuration first. Tapping “?” brings the user to FIG. 21A. If the user taps the virtual “RECORD” button, recording begins. The green OK icon may be tapped to exit or complete. For purposes of this feature, the frame may be reset or resized to 1/9th if the size is greater than ¼ the screen and if this is the first time accessing this screen in a sequence.

A “Configure Zoom—Continued” screen is shown in FIG. 21D. These are similar options to those of the Object Move effect. The “Zoom Range” option allows the user to configure a different maximum and minimum zoom level.

### Camera Effects: Other

“Tracking” is a camera effect that acts like a video game camera, in that it follows the movement of the player in the middle of the screen. In some embodiments of the software, this feature may be added to a character's effect list, such that the object being tracked can be identified. The Tracking effect will have few options, since the character movements determine what happens to the camera. However, one control or option for the Tracking effect may be “sensitivity level”, such that the user can control how much movement away from the previous mark starts the camera in motion, so it does not jump on every slight movement.

“Shake” is another camera effect that can be added to the software. The Shake effect may be a repackaging of existing camera effects, by moving or rotating them quickly in loops. Different types of shaking may be supported, corresponding to the different types of camera movements previously discussed.

“Scene Transitions” are other camera effects that can be added to the software. Such effects may include one or more of fading, blurring, flipping, and stretching the entire canvas.

### Trim Tool

With this feature, a user can trim any time segment by toggling the “trim” tool on.

### Trim Tool—Trim Mode vs Normal Mode

To assist the reader's understanding of this feature, a “Trim Tool” screen is shown in FIG. 22A, and a “Trim Adjustments Mode” screen is shown in FIG. 22B.

With trim selected, the end markers and line indicator for an effect turn a different color (e.g. turning from blue to red), highlighting that the user is in “trim” mode. During Trim Mode (red), when adjusting the left marker, it adjusts the effect's timing either by adding padding before the effect starts (move left) or by cutting off the early sequences of the effect (move right). When adjusting the right marker, it also adds time to the end of the sequence (move right) or cuts off part of the sequence (move left). When trimming the effect past the current sequence length so some cuts off, that part turns grey and is never seen, but we can always come back later and adjust it back into the sequence (it does not disappear completely). By toggling the Trim tool again, the software returns the user to the normal mode. The Normal Mode (blue) adjusts the beginning point with the left marker and slides the entire effect over. Moving the right marker adjusts the speed of the effect evenly.

### Other Effects

Here we discuss rules & requirements for effects other than the Move Effect.

### The Rotate Effect—User Applies Rotate

In regard to an optional FTUE/“SHOW ME” OPTION, a “User Accesses Rotate” screen is shown in FIG. 23A. ROTATE EFFECT DEMO: from the effects panel, the user accesses rotate. If it is the first time the user will see an FTUE prompt indicating and demonstrating how to rotate the figure with one finger. The demonstration may show both clockwise and counter clock-wise rotation. Pressing continue in the FTUE allows the user to rotate the object over time from where the playhead currently is placed.

An “Effect Applied” screen, which includes a virtual RECORD button, is shown in FIG. 23B. ROTATE FUNCTIONALITY: the user sees animations occurring but does not see the timeline, i.e., the timeline is hidden. The user can rotate the character, or another object or objects, over 360 degrees (multiple rotations), and each degree of this rotational motion is counted in the recording session for the animation. The user can also reverse the rotation by reversing the direction of motion of the touch point (created by their finger), and this reverse motion is also recorded. Once the user has finished rotating by lifting their finger from the touch screen, the recording session ends, the timed motion data is stored in memory, and the effect is applied to the timeline.

ROTATIONAL AXIS or PIVOT POINT: By default, the object's pivot point is placed at the designated center of the object. The relative position of this pivot point can be changed AFTER the user does an initial rotation in the “Rotate Config Options” screen of FIG. 23C, or the user can click the configuration “gear” icon to first access the control for pivot point. EDIT PIVOT POINT: this target-shaped virtual button allows the user to adjust where on the object the animation should pivot. Tapping this button loads a “Rotate Pivot Point Update” screen such as that shown in FIG. 23D. The user still sees the timeline and can adjust the pivot point and hit play to test the effect changes based on its location. By pressing OK, the user locks in the new pivot point location.

RECORD: This button allows the user to draw or redraw the rotate effect starting at the current playhead location. LOOPS: Loops in this case loops the entire animation and does not note the number of full rotations made—for example, if the user draws a 25 degree rotation in the animation with their finger and reverses after 25 degrees by 90 degrees during a defined recording session, then the full animation of this will repeat. This slider can also be moved all the way to the end for infinite loops, or as many as technically feasible. FINISH UPRIGHT: this snaps any existing animation back to its original position at the end. AUTO-ROTATE: This overwrites any draw animation and allows the user to auto-rotate an animation 360 degrees based on the number of “rotations” indicated in the rotations slider. ROTATIONS: this slider lets the user manually set the number of 360 degree rotations the user would like to have. This is disabled if the user does not have auto-rotate toggled on. RETRACE: this reverses any clockwise rotation to be counter-clockwise once it is at the end of its original animation. This can also be used with auto-rotate once all rotations play. This also ADDS time to the animation, using equivalent time to create the initial effect.

### The Scaling Effect

### Scaling: Uniform—User Applies Uniform Transformation

In regard to a FTUE/“SHOW ME” OPTION, an optional “User Accesses (Uniform) Scale” screen is shown in FIG. 24A. SCALE EFFECT DEMO: From the effects panel the user accesses scale, and FTUE is demonstrated. The slider is moved up and down, starting in the middle, with corresponding scaling of the character from 0× (bottom) to 1× (middle) to 10× (top). If the user selects “Continue”, they begin recording. Otherwise, they can click the gear icon to first adjust the configuration.

A “Uniform Scale Effect Applied” screen is shown in FIG. 24B. SCALE FUNCTIONALITY: the user sees animations occurring while recording. The user slides their finger to scale the object uniformly—this is a uniform magnification or demagnification and does not skew the object in any way. The user can also REVERSE the direction of the scale and have it shrink in the same recording session. Once the user has lifted both fingers, the effect is applied to the timeline, and the recording is complete. The act of lifting both fingers from the touch surface completes all recording sessions.

SCALE PIVOT POINT: by default, scaling centers on the designated center of the object. This can later be adjusted in the configuration options to change the direction of the scale. This difference will be most noticeable on objects that are not perfectly square in aspect where the user wants the object to scale in a specific direction. See the “EDIT PIVOT POINT” comment below. SCALE RANGE: the slider is moved up and down at an increasing rate, starting in the middle, with corresponding scaling of the character from 0× (bottom) to 1× (middle) to 10× (top). In some embodiments, a slider may be added to modify the scale range away from 10×.

PREVIEW: there is no noticeable preview for scale when the animation is paused, but the user can scrub the timeline to preview how the object scales in real time. ALTERED START POSITION: if the user taps part of the slider that is not in the hitbox at the start of recording, the initial value may be set to that new location. The software also preferably re-centers the slider under the hitbox region regardless if it hit the hitbox or not. This is effective for copies, for example, where the software does not adjust to full-sized, but rather start invisible and grow to the correct size.

A “Scale Config Options (Advanced Scaling Disabled)” screen is shown in FIG. 24C. EDIT PIVOT POINT: this target-shaped button (or bullseye, see the pattern of concentric circles in this figure) allows the user to adjust the position of the reference point on the object relative to which the animation will scale from. Tapping this button loads a “Scale Pivot Point Update” screen such as that shown in FIG. 24D. Initially, all objects scale from the center, but by allowing the user to change the pivot point (reference point), the software allows the object to scale (expand from or shrink towards) relative to any given corner or point. In some embodiments, the user may rotate using a second finger to adjust the orientation of the pivot. This may be particularly useful if the scaling includes horizontal or vertical and needs to be adjusted from a different angle. Vertical/horizontal may be determined by object position or by original object position.

RECORD: this virtual button allows the user to record or re-record the scale effect starting at the current playhead location. LOOPS: looping in scale is an easy way to have the object continually expand or contract up to a certain point. Looping takes the initial scale amount drawn by the user and multiplies it continually in the same direction. Looping is set to 0 by default. RETURN TO START: when toggled on, this resets the object to its initial 100% scale value at the end of the animation, and if looped, prior to each loop beginning. This is instant, and is toggled off by default.

RETRACE: this reverses the scale in the opposite direction using the same value initially created, but in reverse after the animation plays. For example, if the object is scaled 2×, it will now be shrunk by 2× after the initial scale. If it is a combination of shrink/expand, the object will reverse all steps. This also ADDS time to the animation, using equivalent time to create the initial effect.

### Advanced Scaling—Other Scaling Transformation Options

A “Purchase Options—Advanced” screen is shown in FIG. 25A. PURCHASE ADVANCED SCALING OPTIONS: demonstrates the advanced scaling options with animated gifs that alter the same object. When purchased, those advanced features become unlocked.

“Purchase Applied” screens are shown in FIGS. 25B and 25C, BUTTON TO PURCHASE: disappears and effect options become active. Invert is a toggle option, while the others are the actual function. SCALE RANGE: these new options appear when advanced options are purchased. Click to adjust max value from 1 to 1000 (default is 10). If set to 1, the scale goes from 0 to 1 during recording, and the slide head starts at the top, as opposed to the middle where it normally starts. Min can be set to 0, 0.5, or 1. If Invert is selected, it can go to −1000 (i.e. negative 1000). INVERT: allows the ability to go into a negative scale. Selecting this will change the Min scale range to −10 by default. FLIP: this removes any “tween” states and sets the item to a full reversed state.

### V/H Scaling—Vertical & Horizontal Transformations

A “Directional Scaling” screen is shown in FIG. 26A. VERTICAL & HORIZONTAL SCALING: allows users to scale horizontally and vertically at the same time, but in some cases it may not support random angles. In cases where FIG. 24D is implemented, the software can re-orient what is considered vertical and horizontal. The approach of FIG. 26C (below) may have some of the same limitations, in which users may only scale in 2 directions at a time, but its design may be more consistent with the approach taken in FIGS. 26A and 26B and may be easier to control. In this regard, a “Vertical Scaling” screen is shown in FIG. 26B, and a “Horizontal Scaling” screen is shown in FIG. 26C. In FIG. 26C, the user can use 2 fingers to scale vertically and horizontally at the same time, including inverting, and records this motion over time during a recording session.

By Default, scaling is set at 0 to 10, with the center point being 1×. However, users can modify scaling from −1000 to +1000, where negative indicates the object is flipped. User slides the marker up and down, and the character shrinks and grows vertically and horizontally over time, until the finger lifts. Pivot point affects centering of the scaling, but also the pivot angle (if applicable) sets what direction is vertical.

VERTICAL SCALING: the user can choose to adjust scaling in any single direction, or if coordinated enough, try both at same time. However, if the user chooses a single direction, they can also stack it with separate effects for horizontal and vertical. That is, the software can automatically combine the animation created for the single direction with animation(s) for the horizontal and/or vertical directions to yield a net or combined animation that includes both or all effects.

### Freeform Scaling

A “Freeform Scaling” screen is shown in FIG. 27A. ALTERNATIVE FREEFORM: in this approach, the software uses a ring surrounding the object to give the user a clearer picture of how the transformation is occurring, and instead of using sliders, the user drags his or her finger across the object. The user may drag from the ring edge as a guide, but can in fact drag from any position, causing the ring and character to stretch in any direction towards or away from the pivot point (reference point). Examples are shown in FIGS. 27B, 27C, and 27D. This software function offers a “shear” effect. The pivot point is preferably kept visible so the user can understand clearly the threshold being passed to invert to negative.

A benefit of this effect is to allow the user to adjust from any direction, creating warps that, when stacked or combined with other scaling effects or other disclosed effects, are unable to be achieved with the other methods, since the other approaches may only allow vertical/horizontal scaling. Further, no directional setup is useful for the pivot since the user controls it by the direction to/from the pivot. And no multiplier values are needed.

However, to achieve scaling from multiple directions, the user needs to lift their finger from the touch screen while recording, which typically stops the recording in other animations. To account for this, a green OK button appears during the recording session, or instead, a red button labeled “stop recording” may be used at the bottom of the screen to end the recording session. The +/− range still applies, which determines the extent of stretching possible and inversion.

### Visibility Effect

### The Visibility Effect—User Applies Visibility

In regard to a FTUE/“SHOW ME” OPTION, a “User Accesses Visibility” screen is shown in FIG. 28A. VISIBILITY EFFECT DEMO: from the effects panel, the user accesses visibility. In the optional FTUE demonstration, the circle (bullseye icon) representing a drag motion moves up and down over the screen. As the circle moves, the object fades. Down is towards 0% opacity. Up is towards 100% opacity. The value shown in the upper left of the screen adjusts as the slider is moved. This effect does not necessarily require the option to configure as described with other effects.

A “Visibility Effect Applied” screen is shown in FIG. 28B. VISIBILITY FUNCTIONALITY: as the circle (bullseye icon) moves, the object fades. Down is towards 0% opacity. Up is towards 100% opacity. There is a faded overlay to show the range control so the user can more easily control expectations for what is happening. The marker starts at the baseline opacity position. The value in the upper left adjusts as the slider moves.

PREVIEW: When the animation is paused, the object has the current visibility of its point in the timeline. The user can also scrub the timeline to preview how the object changes in visibility in real time. RECORDING: the user touches the visibility marker which begins recording the animation. As the user slides between 0 and 100% visible, keyframes are recorded. When the user lifts their finger, recording ends. ALTERED START POSITION: if the user taps part of the slider that is not in the hitbox at the start of recording, the initial value can be set to that new location. The slider can be re-centered under the hitbox region regardless if it hit the hitbox or not. This will be effective for copies, for example, where it is not desirable to adjust from visible, but rather start invisible and grow to visible.

A “Visibility Config Options” screen is shown in FIG. 28C. STROBE: full opacity or none, with no tween gradients. RECREATE VISIBILITY: this button allows the user to redraw or re-record the visibility effect starting at the current playhead location. LOOPS: looping in visibility is an easy way to have the object continually flash or strobe. Looping takes the initial visibility effect and repeats it, returning to the start every time until its last loop. AUTO-HIDE: Auto-Hide instantly hides the object at the moment the effect was applied, over-riding any recorded visibility effects. The effect length should change to reflect this. The recorded effect is still stored in the device memory in case the user toggles this off. This is set to off by default. RETRACE: This retraces the effect from 0% to 100% opacity. For example, if the user starts at 20% opacity and goes to 50%, this would then go back down to 20% after the initial 20% to 50% increase. This also ADDS time to the animation, using equivalent time to create the initial effect. If looping is toggled on, looping includes both the initial effect and the retrace in I single loop. This is toggled off by default.

### Further Discussion

We have thus described, among other things, methods for dynamically manipulating an attribute of a virtual object (including abstract objects) to be animated over a time sequence, the methods employing the user interface of an electronic device as part of a software program that includes a function where an animation effect is applied to the object to produce some appearance of motion, or other change in visual appearance of the object over time, from keyframe to keyframe. In the method, the object is selected on the visual display of the device in order to apply an animation effect to the object, and a pointer position is provided that corresponds to at least one attribute of the object or its effect at a given time. The position of the pointer is then monitored over the timeframe of an extended recording session, and the measured position as a function of time over that recording session is stored as a position data string. The program interprets different positions of the pointer as different values of the object's selected attribute, and converts the position data string to a data string of attribute values. In the simplest case, the position data string is used without any modification as the data string of attribute values, while in other cases filtering techniques, replication techniques, or other techniques can be used to derive the data string of attribute values from the position data string. Each data string includes a plurality of distinct points, typically tens or hundreds of points (but fewer are also possible), and in some cases some (or all) of the points in the data string may have the same value if the user chooses to keep the pointer stationary during some (or all) of the recording session. The rendered playback of the frames of the object will then display the object as exhibiting changes in the appearance of the selected attribute automatically as a function of the position of the pointer that was traced out by the user during the recording session, and not merely by the program generating “tweening frames”.

The pointer position can be in the form of a cursor icon as with a personal computer, but does not need to be physically represented, and in the case of mobile devices, is not likely to have a physical representation, but rather corresponds to the focal point on the screen being touched.

The pointer position may be determined by: a continuous movement of a stylus, mouse, fingertip(s), or eye tracker; taps or gestures of fingertip(s), stylus, or mouse; eye tracking focus or gestures; continuous touch pad movement; and/or touch pad taps or gestures. The recorded positions may correspond to values of the attribute(s) of the object such as: an on/off toggle; a slider position; a selection of objects to choose from; a chart such as a color wheel, an x-y coordinate graph such as two attributes can be manipulated at one time; a position along a path; a new path being defined by the input motion; an invisible path such as swiping up and down or left and right; and/or multiple attributes represented at the same time using any combination of the above.

If desired, a smoothing curve can be applied during or after the recording by the program to simplify the animation motion such that it reduces unintended jerkiness in the change of the attribute from one keyframe to another, and so that any keyframes that are missing or adjusted are filled in automatically by the program according to the values of the algorithm.

The object selected for animation may be a virtual object that remains visual on the screen during animation playback, including: a shape; a virtual character; a virtual object; a line stroke; the background object; and/or any grouped combination of the foregoing objects. The object selected for animation may also be an abstract object that does not itself have a physical virtual representation on the screen during animation playback including: the canvas position, (e.g. camera shake/rotate/fade); the scene selected (e.g. swapping scenes over time or fade in/out); and in some cases an audio object rather than, or in addition to, visual object(s), such as an audio recording (e.g. adjusting the volume).

The attribute (of the object) being adjusted to produce the animation may be “physical” in nature, such as the x, y, or z coordinate of the object's position on the screen or relative to other objects, or the rotation/orientation of the object, or the scale of the object, or the opacity of the object, or the zoom or position or rotation of the canvas/camera, or the volume of an audio track. The attribute to be adjusted may instead be “abstract” in nature, such as the mood of a character (e.g. as shown by physical expressions of the character), or intensity, or vitality (life), (e.g. a plant thriving or withering, or a character energizing or dying). The attribute to be adjusted may also be a combination of such physical and abstract attributes or effects.

The selection of the effect may occur by, for example: a set gesture associated with the object translates to a type of effect selected; a menu appearing upon selection of the object where the user can select the effect; and/or a menu appearing upon selection of the object where the user can choose to add effects and then choose the type of effect.

The start of recording may begin for the effect selected as follows: immediately upon selecting the effect; by selecting a record button option; by touching the screen; by touching or dragging the object; by touching or dragging the marker on a representation of the attribute; and/or an audible cue spoken into a microphone of the electronic device. The end of recording for the effect may be triggered as follows: lifting the user's finger or stylus from the touch-sensitive surface; a particular predefined gesture; a tap on a button (such as record/pause/stop); a click or double-click on a mouse device or track pad; double-click your mouse; and/or an audible cue spoken into the microphone of the device.

Additional filters and methods may also be added to the effect, such as: a replacement of the timing curve (e.g. a straight line or set motion in/motion out timing sequence); re-tracing the effect so it plays the effect in reverse after playing it forward; looping multiple iterations of the effect; looping multiple iterations of the effect along with its re-traced effect; returning the object to an upright position; re-positioning or re-orienting the object on the fly as the object moves along a defined path; cropping the effect so only portions play; scaling the timing faster or slower; and/or manually adjusting the timing. The effects may be stacked together, i.e., combined, either independently as effects of the object or objects selected or as a result of a parent object that impacts the object rendering, such that the combination of effects are all analyzed together in order for the software to determine the rendering of every keyframe for the object.

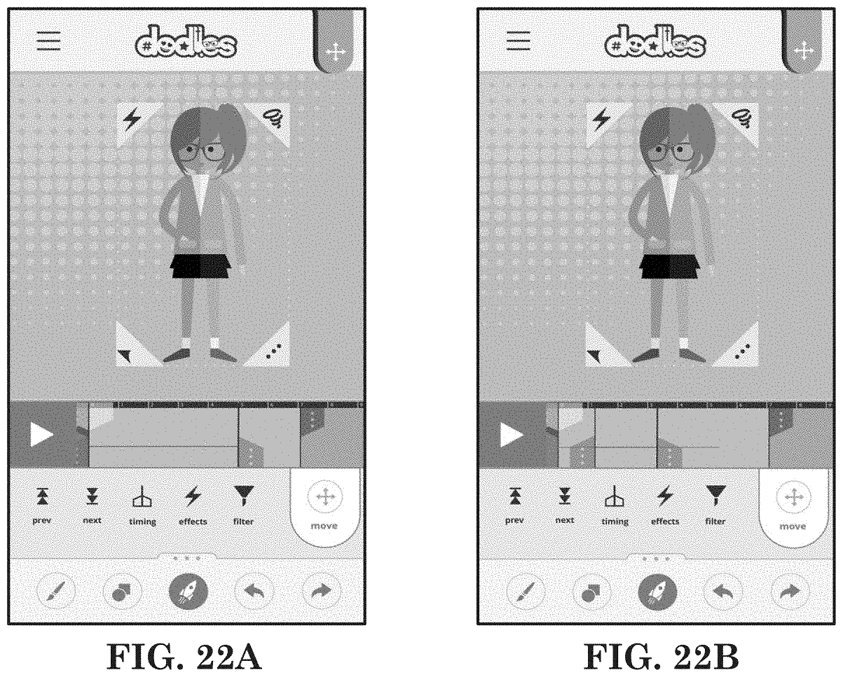

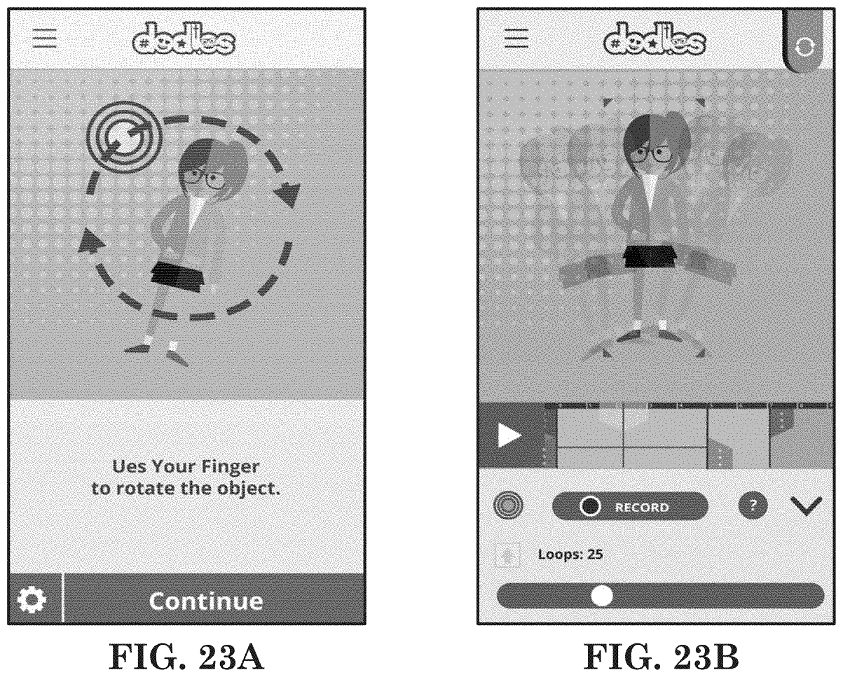

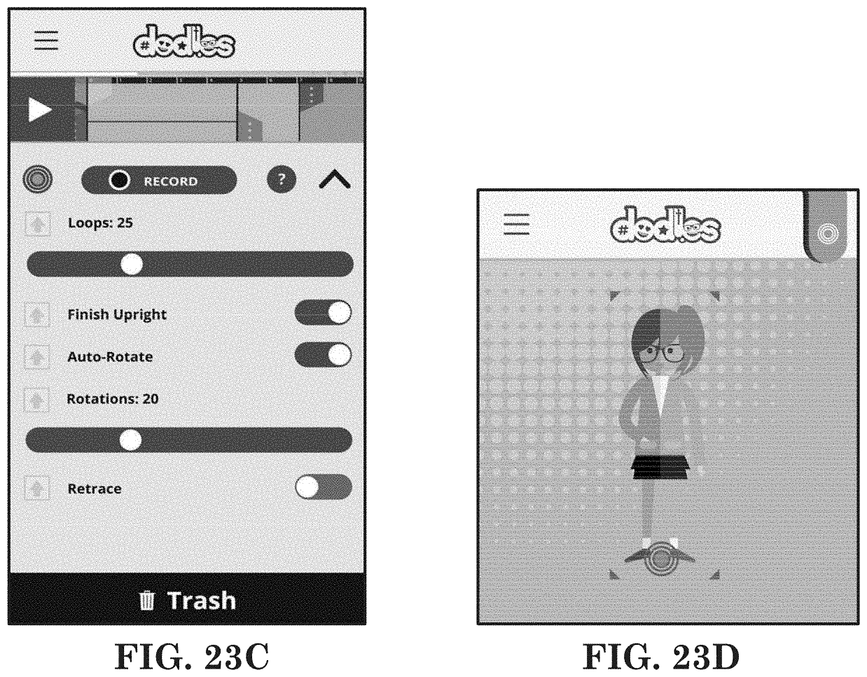

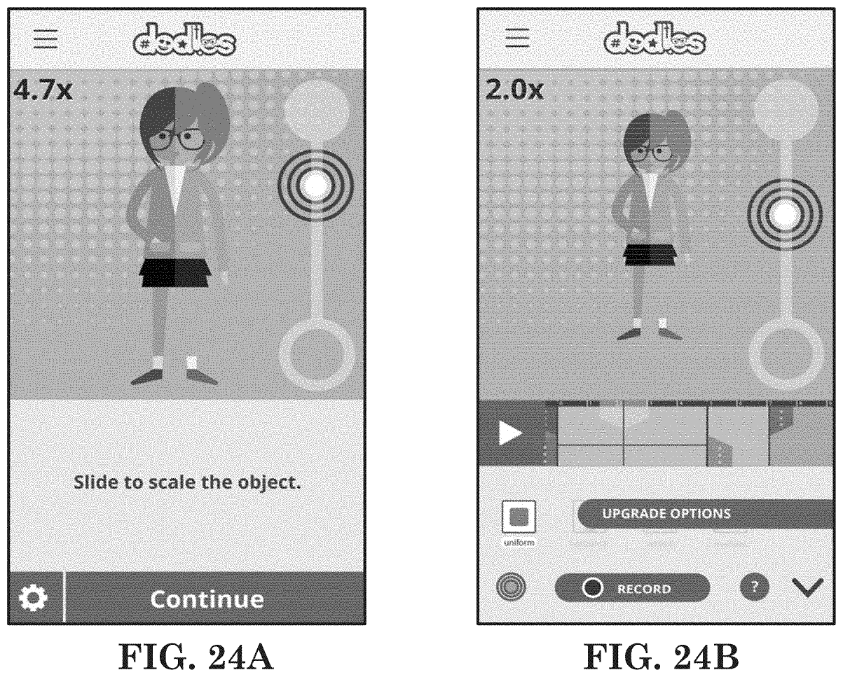

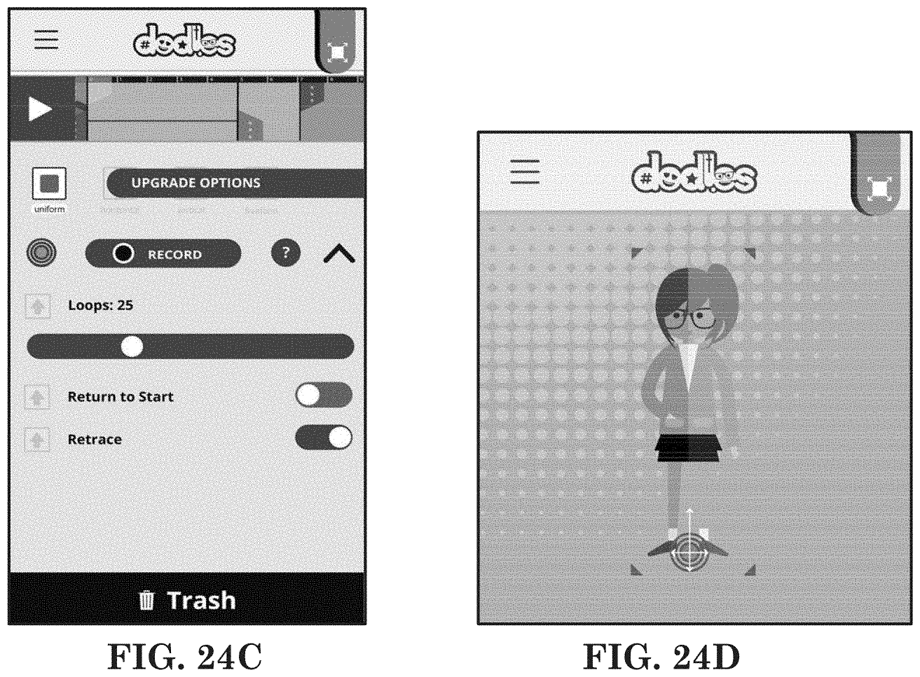

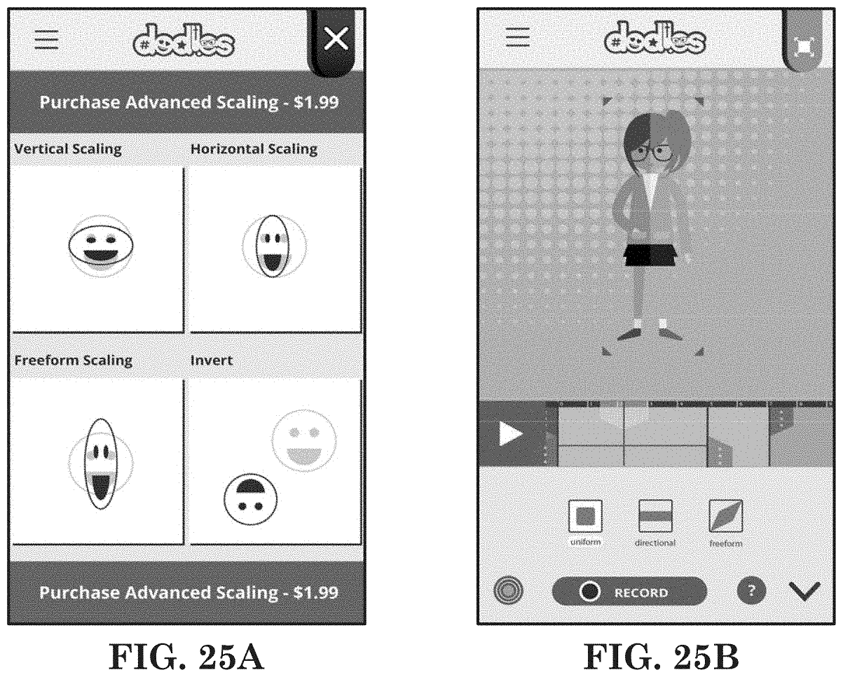

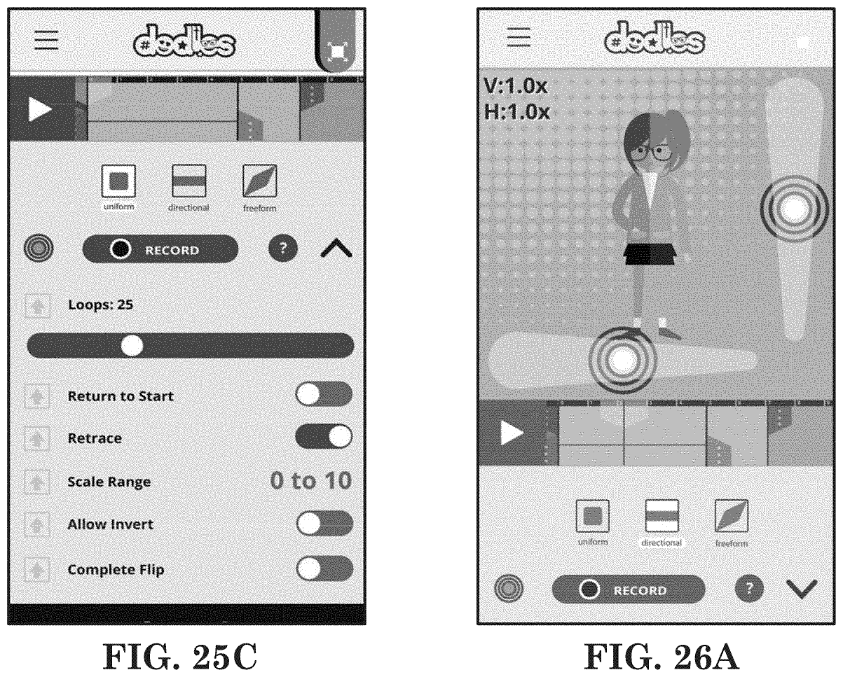

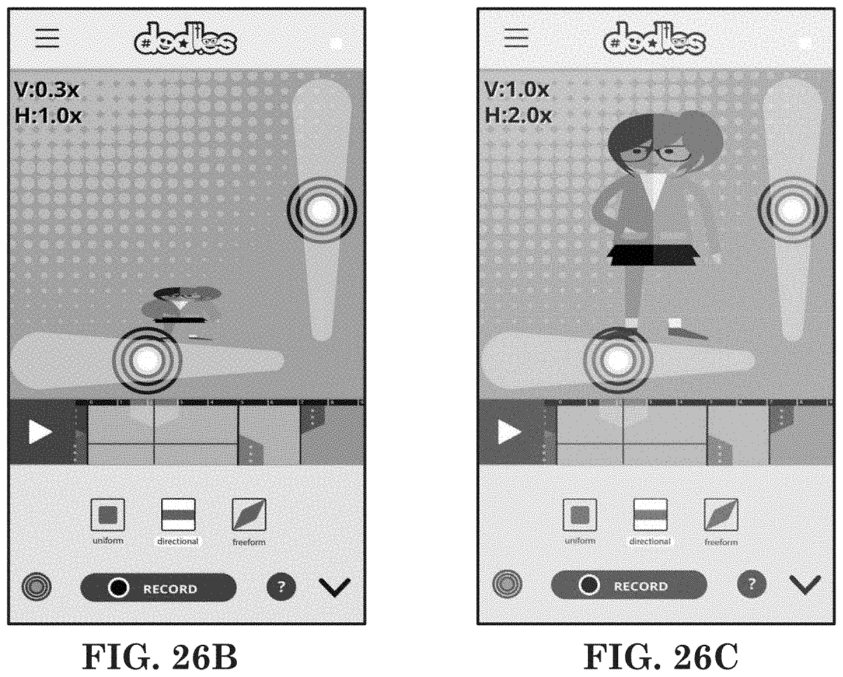

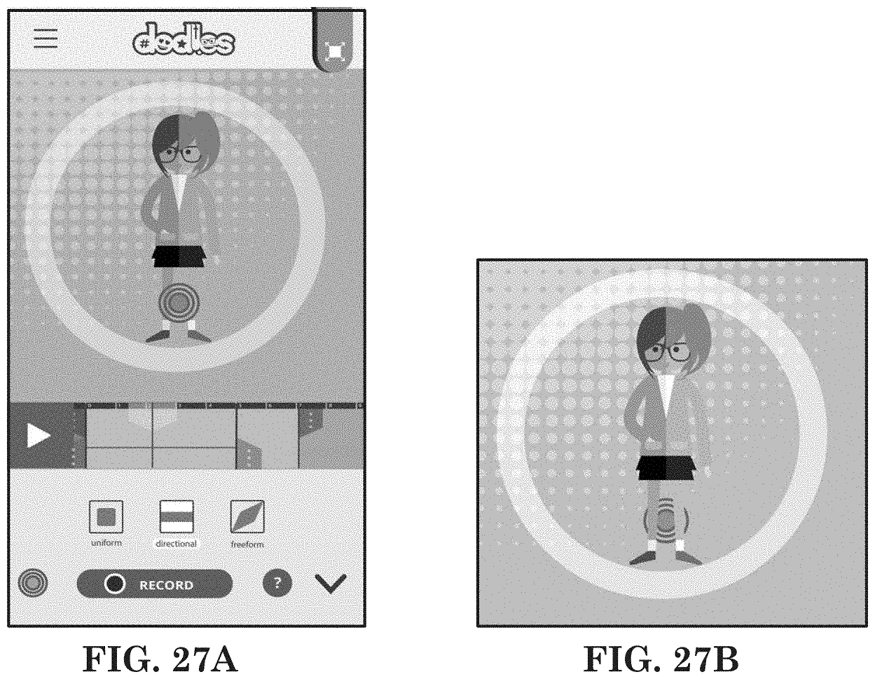

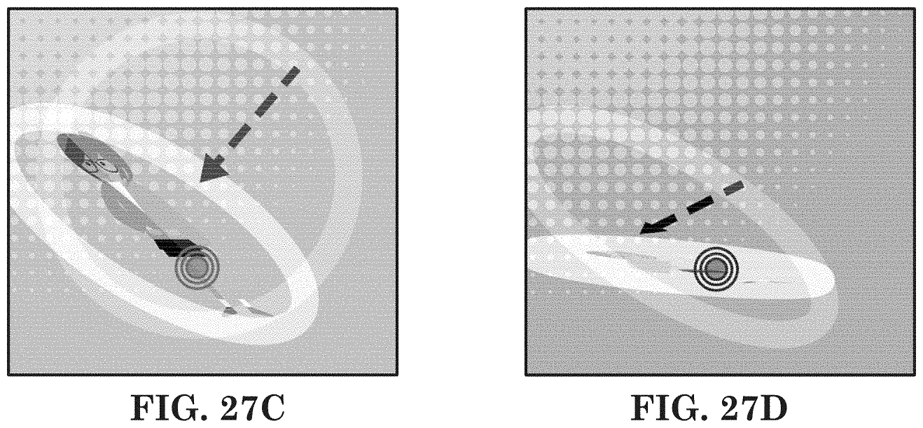

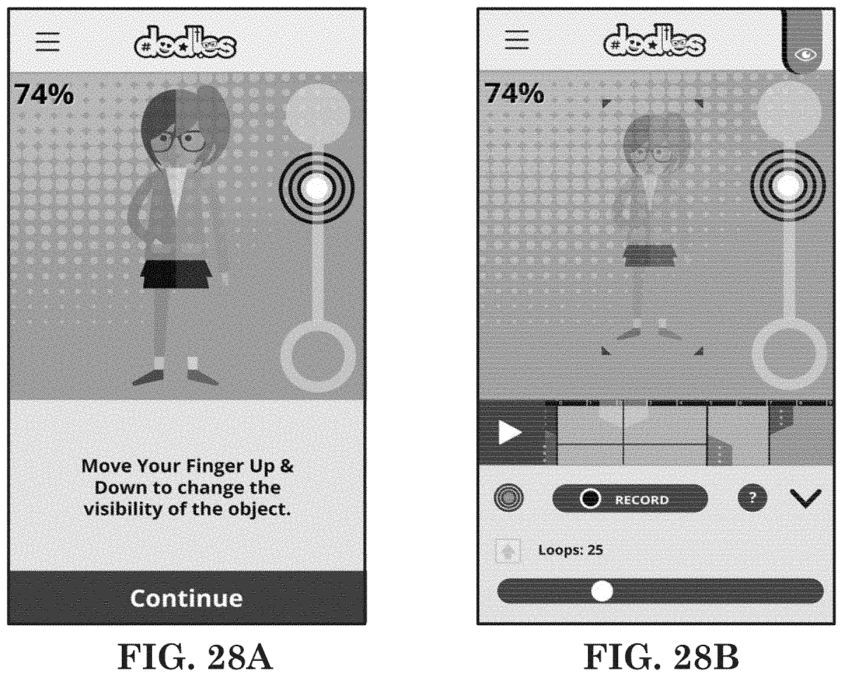

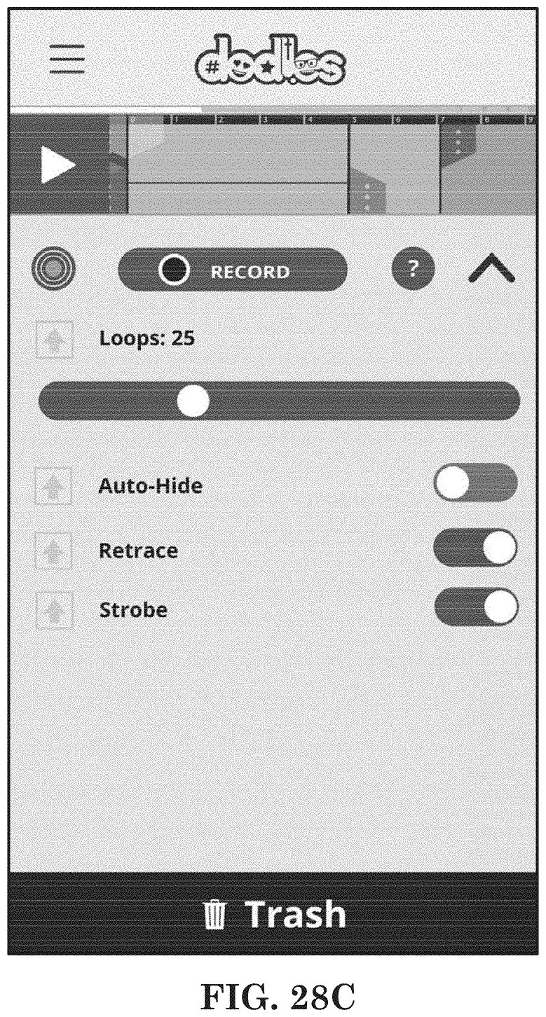

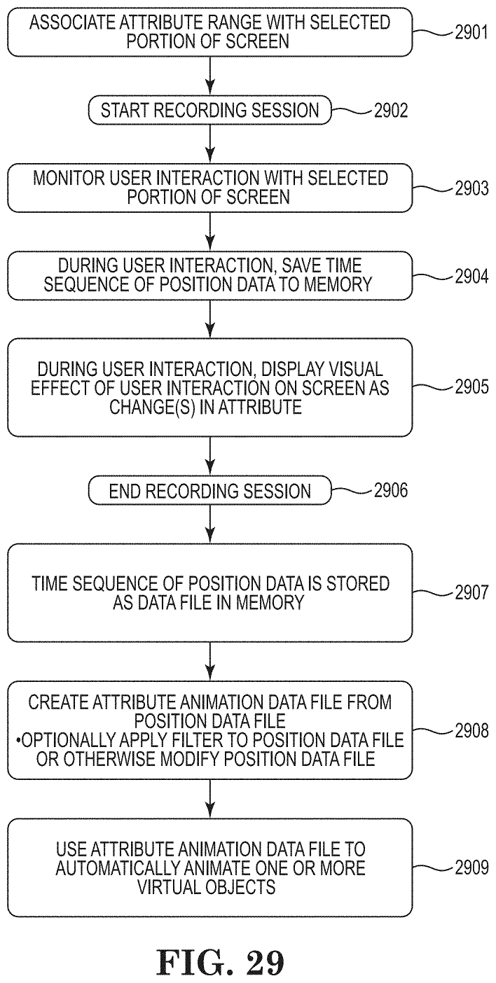

Turning now to FIG. 29, a flowchart is provided there showing a technique for simplified animation as described herein that involves taking a recording of a user interaction with a portion of a touch screen associated with an attribute of a virtual object.

In step 2901, a selected portion of the screen is associated with an attribute range for an object of interest. For example, in the display of FIG. 12A, a large square or rectangular region in which the character is located, is associated with a position or location of the character (object). As another example, in the display of FIG. 19D, a similar large or square rectangular region is associated with a position or location of a canvas or camera frame (object). As yet another example, in the display of FIG. 21B, an elongated teardrop-shaped region is associated with a zoom or magnification of the character (object). These are only a few of the many more examples provided above.

In step 2902, the user starts the recording session. This may be done by touching or pressing a virtual RECORD button, for example, or by first touching the touch screen after pressing such button, or in other ways discussed above.

In step 2903, the system monitors the user's interaction with the selected portion of the screen during the recording session. For example, the system may monitor the location of the touch point within the selected portion of the screen at the refresh rate of the display screen or at another selected rapid interval, e.g. as the user moves the touch point along a motion path if they so choose. In step 2904, the string or sequence of such monitored locations is saved to the memory unit of the device. The saved information thus is or includes a time sequence of position data representing the location of the user-controlled touch point within the selected portion of the screen as a function of time during the recording session.

Step 2905 is optional and may be omitted, but can provide helpful feedback to the user during recording. If included, the visual effect of the user's interaction is displayed as changes in the selected attribute of the object. For example, in the display of FIG. 12A, the selected attribute is the position of the character (object), and the program may cause the character to follow the position of the touch point in real time as the user traces out a motion path with the touch point during the recording session. As another example, in the display of FIG. 19D, the selected attribute is the position of the canvas or camera frame (object), and the program may cause the frame to follow the position of the touch point in real time as the user traces out a motion path. In yet another example, in the display of FIG. 21B, the selected attribute is a zoom or magnification of the character (object), and the program may cause the character to appear magnified or demagnified in real time as the user traces out a motion path. These are only a few of the many more examples provided above. In cases where step 2905 is omitted, no visual effect may be provided on the display during the recording session to provide the user with feedback on how the appearance of the object will change as a result the controlled movement of the touch point.

In step 2906, the recording session is ended or stopped. This may be done by lifting the user's finger off of the touch surface, or by touching or pressing the virtual RECORD button a second time, or by touching or pressing another virtual button provided on the screen, or in other ways discussed above.

In step 2907, the time sequence of position data that was monitored during the recording session is stored as a data file in the memory of the device. This may represent the completion of the storing or saving process carried out in step 2904. The saved position data may be a string of data points representing the position of the user's touch point at the sampled time intervals during the recording session. In some cases, each such data point in the string of data points may have only one numerical value representing a position along a particular in-plane axis on the touch screen. For example, in the case of the display of FIG. 21B (where the attribute region extends predominantly along the vertical or y-axis of the screen), only the vertical position (y-coordinate) of the bullseye icon (touch point) within the elongated teardrop-shaped region is relevant to the program; hence, in that case, each data point in the saved position data may have only a y-coordinate value, and no x-coordinate value. In other cases, such as in the display of FIG. 12A (where the attribute region extends along orthogonal x- and y-axes of the screen), both the vertical and horizontal components of the touch point are relevant; hence, in such cases, each data point in the saved position data may have both an x-coordinate value and a y-coordinate value. The x-coordinate values in such position data string may define an x-axis position function, while the y-coordinate values define a y-axis position function.

In step 2908, an attribute animation data file is created from the stored position data file. This may be expressed alternatively as converting the received and stored position data to a data file or data string of attribute values. In some cases, the “converting” or “creating” may involve no modification of the position data, and may consist of nothing more than designating, or using, the stored position data file as a data file or data string of attribute values. In other cases, the program may employ one or more filtering techniques, replication techniques, or other data processing techniques to derive the data string of attribute values from the input data string. If the position data is 2-dimensional, e.g., if each position datapoint contains both an x-component and a y-component, the x-values may define an x-position function and the y-values may define a y-position function, and a first attribute function may be derived from the x-position function, while a second attribute function may be derived from the y-position function.

In step 2909, the software program uses the animation data file, e.g. the data string of attribute values, to automatically animate a designated object, such as the object that was the subject of the recording session. For example, in connection with FIG. 12A, the program causes the character to move on the screen in accordance with the (2-dimensional) data string of attribute values, which is derived from, and in some cases may be substantially the same as, the (2-dimensional) position of the touch point traced out by the user during the recording session. Alternatively, in connection with FIG. 19D, the program causes the canvas or camera frame to move on the screen in accordance with the (2-dimensional) data string of attribute values in similar fashion. Alternatively, in connection with FIG. 21B, the program causes the character to zoom in or out in accordance with the (1-dimensional) data string of attribute values.

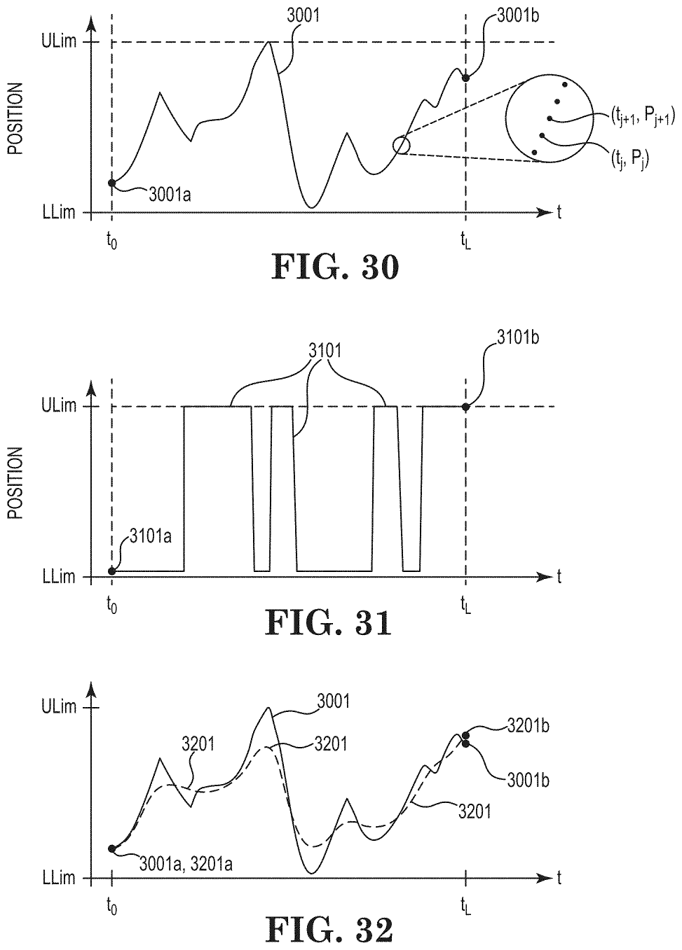

A graph of a curve that represents hypothetical or possible user-generated position data that the system uses to produce automated animation effects is shown in FIG. 30. The graph plots position along a given axis (such as an x-axis or a y-axis in the plane of the screen) on the vertical axis, and time on the horizontal axis. The position axis is labeled with a lower limit LLim and an upper limit ULim, representing the lower and upper edges of the touch screen or relevant portion thereof. On the horizontal axis of the graph, the time t₀ represents the beginning of a recording session, and time t_{L} represents the end of the recording session. The duration of the recording session is not limited and may be selected as desired by the actions of the user, but in many cases will be in a range from 1 second to 60 seconds, or from 1 second to 10 seconds. During the recording session, the user controls the position of the touch point as desired, and may trace out a simple or complex continuous path across or along the surface of the touch screen, which path may be referred to as a motion path. The curve 3001, with a starting point 3001a and an ending point 3001b, represents the position data for one coordinate (e.g. an x-coordinate or a y-coordinate) of such a path. While this control or movement of the touch position is occurring, the system monitors the location or position of the touch point at a sampling rate that may equal the refresh rate of the display screen, or that may be greater or less than the screen refresh rate. Screen sampling rates on current portable devices are typically in a range from 60 to 240 Hz, or from 120 to 240 Hz, but may in some cases be as low as 24 Hz. Regardless of the sampling rate chosen, the curve 3001 is made up of a plurality of discrete points, including the starting and ending points 3001a, 3001b and at least some (or at least one) intermediate points, as shown at points (tⱼ, Pⱼ), (tⱼ₊₁, Pⱼ₊₁). In typical cases, the curve 3001 may include at least 5 or 10 points, or at least 50 points, or in a range from 50 to 15,000 points, or from 100 to 3,000 points, for example.

In cases where both x- and y-coordinate position information is relevant, the user's action of tracing out a motion path produces two independent position curves, each analogous to curve 3001, substantially simultaneously. For example, if the motion path traced out by the user is one or more overlapping circles, the position graph for the x-coordinate will be a sinusoidal shape, and the position graph for the y-coordinate will be a similar sinusoidal shape with a phase delay.

As discussed above, the position data measured by the device during the recording session is used as a basis for the program's automatic animation of the character or object. In some cases, the position data may itself be used as an attribute data set purposes of the animation. Thus, the curve 3001 in FIG. 30 may alternatively be considered to represent a data string of attribute values, or at least one coordinate (e.g. x- or y-coordinate) of such values. As such, the data string includes a plurality of discrete points or values including a first point, a last point, and at least some (or at least one) intermediate points, but typically at least 5 or 10, or 50, or from 50-15,000, or from 100-3,000 points.

FIG. 31 is a graph similar to that of FIG. 30 but where the hypothetical user-generated position data 3101 is of a binary nature. For example, an attribute input region of the screen may define an area that is split between one half representing a happy expression, and an adjacent half representing a sad expression, where the attribute of interest is the mood of the character. The user may wish to use the software to create an animation where the character shifts between those two different moods according to a time sequence specified by the user. In this case, the relevant position value may take on only one of two possibilities (happy or sad), rather than a wide range of discrete values as in FIG. 30. Nevertheless, the program allows the user to start the recording session at time t₀ and end it at time t_{L}, and monitors, samples, and records the position of the touch point as position data 3101 with starting and ending points 3101a, 3101b, and intermediate points as described above. The program may then use this position data, either as-is or modified by filtering techniques, replication techniques, or other data processing techniques, to derive the data string of attribute values use by the system in the animation.

An example of a smoothing technique is shown in FIG. 32. In that figure, curve 3001 is the same as in FIG. 30, with no further explanation needed. A straightforward smoothing filter can be applied to that curve to smooth out sharp transitions to yield filtered curve 3201. The filtered curve 3201 has starting and ending points 3201a, 3201b, and intermediate points as described above. This is but one example of the many data processing techniques that can be employed to produce attribute data that is not the same as, but that is derived from, the original position data created by the user.

Unless otherwise indicated, all numbers expressing quantities, measurement of properties, and so forth used in the specification and claims are to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application. Not as an attempt to limit the application of the doctrine of equivalents to the scope of the claims, each numerical parameter should at least be construed in light of the number of reported significant digits and by applying ordinary rounding techniques.

Various modifications and alterations of this invention will be apparent to those skilled in the art without departing from the spirit and scope of this invention, and it should be understood that this invention is not limited to the illustrative embodiments set forth herein. The reader should assume that features of one disclosed embodiment can also be applied to all other disclosed embodiments unless otherwise indicated. It should also be understood that all U.S. patents, patent application publications, and other patent and non-patent documents referred to herein are incorporated by reference, to the extent they do not contradict the foregoing disclosure.

1. A method for automating animation on an electronic device, comprising:
providing an electronic device having a processor, a memory, and a screen, the processor configured to provide video signals to the screen, and to read and write information to and from the memory;
displaying graphics on the screen, and defining one or more attribute input regions on the screen, different locations on the attribute input region(s) corresponding to different visual attribute values for a virtual object to be displayed on the screen;
receiving user position signals produced by a user interacting with the attribute input region(s) over a recording period;
converting the received user position signals to a data string of attribute values over the recording period;
storing the data string of attribute values in the memory; and
displaying on the screen an animation of the virtual object over an animation period by retrieving the data string of attribute values from the memory and causing the processor to generate the animation using the retrieved data string of attribute values.

2. The method of claim 1, wherein the attribute input region extends along orthogonal x- and y-axes of the screen, and wherein the user position signals include position data points that define both an x-axis position function over the recording period and a y-axis position function over the recording period, and wherein the data string of attribute values defines both a first attribute function and a second attribute function, the first attribute function based on the x-axis position function, and the second attribute function based on the y-axis position function.

3. The method of claim 1, wherein the attribute input region extends predominantly along a given in-plane axis of the screen, and wherein the data string of attribute values defines a first attribute function based on a component of the received user position signals along the given in-plane axis, but wherein the data string of attribute values does not define a second attribute function based on a component of the received user position signals along a second in-plane axis perpendicular to the given in-plane axis.

4. The method of claim 1, wherein the user position signals received over the recording period define at least a first position function along one in-plane axis, and wherein the data string of attribute values define at least a first attribute function substantially the same as the first position function.

5. The method of claim 1, wherein the user position signals received over the recording period define at least a first position function along one in-plane axis, and wherein the data string of attribute values define at least a first attribute function derived by filtering the first position function.

6. The method of claim 1, wherein the data string of attribute values relate to a position of the virtual object on the screen, and wherein the animation causes the virtual object to move along a path over the animation period.

7. The method of claim 6, wherein the virtual object has a predefined longitudinal axis, and wherein the animation adjusts an orientation of the virtual object as it moves along the path such that the longitudinal axis is tangent to the path.

8. The method of claim 1, wherein the animation includes rotating the virtual object.

9. The method of claim 1, wherein the animation includes scaling the virtual object.

10. The method of claim 9, wherein the scaling changes an aspect ratio of the virtual object.

11. The method of claim 9, wherein the scaling does not change an aspect ratio of the virtual object.

12. The method of claim 1, wherein the animation includes changing a visibility of the virtual object.

13. The method of claim 1, wherein the virtual object includes a virtual canvas frame, and wherein the animation includes moving the virtual canvas frame relative to objects that appear within the virtual canvas frame.

14. The method of claim 1, wherein the recording period and the animation period are the same.

15. The method of claim 1, wherein the recording period and the animation period are different.

16. The method of claim 1, wherein the screen is operable as both a display screen and a touch screen, and the user position signals are touch signals produced by the user.

17. A non-transitory computer-readable storage medium having instructions that, when executed by a processing device having a processor, a memory, and a screen, cause the processing device to perform operations comprising:
displaying graphics on the screen, and defining one or more attribute input regions on the screen, different locations on the attribute input region(s) corresponding to different visual attribute values for a virtual object to be displayed on the screen;
receiving user position signals produced by a user interacting with the attribute input region(s) over a recording period;
converting the received user position signals to a data string of attribute values over the recording period;
storing the data string of attribute values in the memory; and
displaying on the screen an animation of the virtual object over an animation period by retrieving the data string of attribute values from the memory and causing the processor to generate the animation using the retrieved data string of attribute values.

18. The storage medium of claim 17, wherein the data string of attribute values relate to a position of the virtual object on the screen, and wherein the animation causes the virtual object to move along a path over the animation period.

19. The storage medium of claim 17, wherein the animation includes rotating, or scaling, or both rotating and scaling the virtual object.

20. The storage medium of claim 17, wherein the virtual object includes a virtual canvas frame, and wherein the animation includes moving the virtual canvas frame relative to objects that appear within the virtual canvas frame.

21. A method for automating animation on an electronic device, comprising:
providing an electronic device having a processor, a memory, and a screen, the screen operable as both a display screen and a touch screen, the processor configured to receive touch signals from the screen and to provide video signals to the screen, the processor also configured to store first information to the memory and to read second information from the memory;
generating a graphical user interface (GUI) on the screen, the GUI defining one or more attribute input regions on the screen, different locations on the attribute input region(s) corresponding to different visual attribute values for one or more virtual objects to be displayed on the screen;
receiving touch signals produced by a user interacting with the attribute input region(s) over a recording period, and converting the received touch signals to a data string of attribute values over the recording period;
storing the data string of attribute values in the memory; and
displaying on the screen an animation of the one or more virtual objects over an animation period by retrieving the data string of attribute values from the memory and causing the processor to generate the animation using the retrieved data string of attribute values.
